(19) United States
(12) Patent Application Publication
(10) Pub. No.: US 2026/0101369 A1
(43) Pub. Date: Apr. 9, 2026

(54) SYSTEMS AND METHODS FOR COORDINATED NON-PRIMARY CHANNEL ACCESS

(71) Applicant: HUAWEI TECHNOLOGIES CO., LTD., SHENZHEN (CN)

(72) Inventors: Mahmoud HASABELNABY, Kanata (CA); Osama ABOUL-MAGD, Kanata (CA); Jung Hoon SUH, Kanata (CA); Yan XIN, Kanata (CA); Sara NOROUZI, Kanata (CA)

(73) Assignee: HUAWEI TECHNOLOGIES CO., LTD., SHENZHEN (CN)

(21) Appl. No.: 18/907,938

(22) Filed: Oct. 7, 2024

(51) Int. Cl. H04W 74/0808; H04W 28/02

(52) U.S. Cl. CPC H04W 74/0808; H04W 28/0278

(57) ABSTRACT

Methods, systems and apparatus for coordinated non-primary channel access (Co-NPCA) are provided. In one aspect, a method involves inter-BSS coordination, where a first AP communicates with a second AP to synchronize NPCA parameters, such as the NPCA primary channel and channel switching delays. In another aspect, a method for intra-BSS coordination allows an AP to inform an associated STA of the NPCA primary channel and receive feedback on channel switching delays. A further method focuses on coordinating transmission opportunities, where an AP receives and acknowledges requests from another AP for NPCA channel switching. The methods may enable more efficient NPCA operation by optimizing channel access across both overlapping and single BSS environments, reducing unnecessary channel switching, and improving power efficiency and performance during NPCA operations.

### CROSS-REFERENCE TO RELATED APPLICATIONS

This is the first application filed for the present application.

### FIELD OF THE INVENTION

The present invention pertains to wireless communication, and in particular to methods, systems and apparatus for coordinated non-primary channel access (Co-NPCA).

### BACKGROUND

Wireless communication systems have evolved to support increasingly complex networking environments, including overlapping basic service sets (OBSSs). Effective channel management within these environments may be important for optimizing network performance and minimizing interference. The non-primary channel access (NPCA) was introduced as a mechanism to address interference from neighboring OBSSs by enabling stations (STAs) and access points (APs) to utilize a secondary channel when the primary channel is busy.

Several schemes for NPCA have been proposed, focusing on different approaches to manage non-primary channel access while maintaining communication efficiency. These schemes include switching to the NPCA primary channel upon detecting an OBSS control frame exchange, such as multi-user request-to-send/clear-to-send (MU-RTS/CTS). This approach, while simple, may miss opportunities when the transmission opportunity (TXOP) does not begin with a control frame exchange. Another approach suggests switching based on detecting the physical layer (PHY) header information of an OBSS physical protocol data unit (PPDU). This method covers cases where frame exchanges do not start with a control frame but requires different rules for different types of OBSS PPDUs.

For example, in high-efficiency (HE) PPDUs, the HE-SIG-A field carries information such as the basic service set (BSS) Color, Bandwidth, and TXOP fields. These fields are used to detect inter-BSS PPDU and manage the NPCA operation accordingly. Similarly, for extremely high throughput (EHT) or ultra-high reliability (UHR) PPDUs, the U-SIG field contains similar information used to facilitate NPCA. For very high throughput (VHT) PPDUs, the VHT-SIG-A field provides bandwidth, group ID, and partial association ID (AID) information, aiding the detection of OBSS PPDUs. However, in non-high throughput (Non-HT) or high throughput (HT) PPDUs, no information is available in the PHY preamble to detect OBSS PPDUs, and the required details can only be obtained by decoding the MAC header, which may introduce delays and inefficiencies.

Despite these advancements, NPCA schemes face several challenges. One challenge is that not all STAs in a basic service set (BSS) will transition to the NPCA primary channel. This can be attributed to hidden APs or non-AP STAs being unable to detect interference from neighboring OBSSs, leading to suboptimal coordination and channel usage.

Additionally, the location of the NPCA primary channel can impact channel switching delay times. Some STAs have low delay requirements where the NPCA primary channel is within their operating bandwidth, whereas some STAs have high delay requirements where the NPCA primary channel falls outside their operating bandwidth. This disparity in delay requirements complicates the process of coordinating channel access, leading to inefficient use of available spectrum and increased latency.

Furthermore, ultra-high reliability (UHR) STAs with NPCA capability may switch to the NPCA primary channel upon detecting OBSS interference, regardless of their immediate communication needs. This unnecessary channel switching increases power consumption without yielding performance benefits, as STAs often revert to the primary channel at the end of the OBSS transmission opportunity (TXOP) duration.

Therefore, there is a need for methods, systems and apparatus coordinated non-primary channel access that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

The disclosure may provide for methods, systems and apparatus for improving coordinated channel access and utilization in overlapping basic service sets (OBSS) within wireless local area networks (WLANs). Some embodiments relate to mechanisms for forming cooperative groups of access points (APs) and stations (STAs) that support shared transmission opportunities, manage diverse channel switching delay requirements, and enable efficient coordination of NPCA switching for enhanced network performance.

According to an aspect, a method is provided to facilitate coordination between two or more APs in overlapping basic service sets to manage non-primary channel access. The method may refer to an inter-BSS NPCA coordination. The method includes sending, by a first AP to a second AP, a first message requesting participation of the second AP in an NPCA coordination. The method further includes receiving, by the first AP from the second AP, a second message confirming the participation of the second AP in the NPCA coordination, the second message including NPCA parameters. The NPCA parameters may indicate one or more of: a location of an NPCA primary channel, a bandwidth of the NPCA primary channel, an associated BSS operating bandwidth, and a maximum NPCA channel switching delay within the associated BSS. The maximum NPCA channel switching delay may indicate a maximum time or duration for a non-AP STA associated with the second AP to switch from a primary channel to the NPCA primary channel. The method may enhance NPCA coordination by allowing APs to exchange messages about NPCA parameters, including NPCA primary channel location, bandwidth, and switching delay. This may improve interoperability and ensures efficient use of the NPCA primary channel across overlapping BSSs.

In some embodiments, the method further includes sending, by the first AP to the second AP, a third message (e.g., an NPCA coordination request or a negotiation request) including recommended NPCA parameters, the recommended NPCA parameters indicating a recommended NPCA primary channel. In some embodiments, the method further includes receiving, by the first AP from the second AP, a fourth message. In some embodiments, the fourth message indicates an acceptance of the recommended NPCA parameters. In some embodiments, the fourth message indicates a rejection of the recommended NPCA parameters. In some embodiments, the fourth message indicates an alternative set of NPCA parameters, the alternative set of NPCA parameters indicating an alternative NPCA primary channel.

In some embodiments, the fourth message indicates the acceptance of the recommended NPCA parameters, and an updated maximum NPCA channel switching delay based on the alternative NPCA primary channel.

In some embodiments, the method further includes assigning, by the first AP to the second AP, an identifier (ID) by setting an associated identifier (AID)12 bits subfield to a value selected from 1 to 2006, 2008 to 2044 or 2047 to 4094.

In some embodiments, the first AP is in a first BSS, and the second AP is in a second BSS, the second BSS overlapping the first BSS. In some embodiments, the method further includes sending, by the first AP to each third AP of one or more third APs, a third message requesting participation of said each third AP in the NPCA coordination. In some embodiments, the method further includes receiving, by the first AP from said each third AP, a fourth message confirming the participation of said each third AP in the NPCA coordination.

According to another aspect, another method is provided for coordinating NPCA within a single BSS by managing channel switching delays and NPCA switching modes. The method may refer to an intra-BSS NPCA coordination. The method includes sending, by an AP to an associated non-AP STA, a first message (e.g., an initial announcement) indicating a location and a bandwidth of an NPCA primary channel, the first message further indicating an NPCA switching mode (e.g., mode 3, an AP triggered-based NPCA switching as described herein) configured to be triggered by the AP. The associated non-AP STA may refer to a STA within a same BSS. In some embodiments, the STA is an UHR STA. The method further includes receiving, by the AP from the associated STA, a second message indicating an NPCA channel switching delay time based on the NPCA primary channel and an NPCA channel switching back delay time based on the NPCA primary channel. The NPCA channel switching delay time may indicate a first time or duration for the associated STA (a non-AP STA) to switch from a primary channel to the NPCA primary channel. The NPCA channel switching back delay time indicating a second time or duration for the associated STA to switch back from the NPCA primary channel to the primary channel. The method may ensure efficient NPCA operation within a BSS improve channel access based on delay times.

In some embodiments, the NPCA switching mode is indicated by a medium access control (MAC) capabilities information field of an ultra-high reliability (UHR) capabilities element.

According to another aspect, another method is provided for coordinating the sharing of TXOP between APs participating in NPCA. The method includes receiving, by a first AP (e.g., a shared AP) from a second AP (a TXOP sharing AP or a Sharing AP), a request message (referring got the Co-NPCA initial control frame or a trigger frame as described herein) requesting that the first AP switch to an NPCA primary channel, wherein the first AP and the second AP are participating in an NPCA coordination. The first AP and the second AP are coordinating APs and may be in a same multi-AP Co-NPCA group. The method further includes sending, by the first AP to the second AP, an acknowledgement message acknowledging the request. In some embodiments, the acknowledgement message refers to a Co-NPCA control response frame, which may be a multi-STA BA frame.

In some embodiments, the request message is comprised in a trigger frame indicated by a trigger type subfield within a common info field.

In some embodiments, the trigger type subfield indicates: a buffer status report poll (BSRP), a multi-user request-to-send (MU-RTS), a multi-user block acknowledgement request (MU-BAR) trigger frame, or a reserved value selected from 9 to 15. In some embodiments, the trigger frame includes a trigger dependent user info field which indicates a flag to a TXOP duration. In some embodiments, the TXOP duration is indicated in a duration field.

In some embodiments, the acknowledgement message is sent in a multi-STA block acknowledgement (BA) frame that includes a per associated identifier (AID) traffic identifier (TID) info field for acknowledging the request, the acknowledging being indicated via a combination of an ACK type subfield and TID subfield of the per AID TID info field.

In some embodiments, the method further includes sending, by the first AP to an associated STA, a trigger frame to indicate switching to the NPCA primary channel. In some embodiments, the trigger frame is the multi-STA BA frame that indicates the acknowledge message. In some embodiments, the trigger frame including a per associated identifier (AID) TID info field. In some embodiments, the per AID TID info field includes a block ACK starting sequence control subfield indicating a type of control info as being NPCA parameters. In some embodiments, the per AID TID info field further includes a block ACK bitmap subfield indicating one or more NPCA parameters including: whether to switch to the NPCA primary channel, an NPCA switching start time, and an NPCA duration.

In some embodiments, the method further includes receiving, by the AP from the associated STA, a report indicating an NPCA channel switching delay time based on the NPCA primary channel, wherein the trigger frame further includes zero, one or more additional per AID TID info fields based on the NPCA channel switching delay time. In some embodiments, the NPCA channel switching delay time indicates a time for the associated STA (a non-AP STA) to switch from a primary channel to the NPCA primary channel. In some embodiments, each of the one or more additional per AID TID info fields (which may in be multi-STA BA frame) includes a corresponding block Ack starting sequence control subfield indicating a type of control info as being intermediate frame check sequence (FCS). In some embodiments, each of the one or more additional per AID TID info fields further includes a corresponding block ACK bitmap subfield including 32 FCS bits.

In some embodiments, the trigger frame (which may be the multi-STA BA frame) further includes a padding user info field with a size based in part on the NPCA channel switching delay time.

According to another aspect, an apparatus may be provided. The apparatus includes modules or electronics configured to perform one or more of the methods and/or implement one or more of the systems described herein.

According to one aspect, an apparatus may be provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium may be provided, where the computer readable medium stores program code executed by a device and the program code is used to perform one or more of the methods and systems described herein.

According to one aspect, a chip may be provided, where the chip includes a processor and a data interface, and the processor reads, by using the data interface, an instruction stored in a memory, to perform one or more of the methods and systems described herein. Aspects may further include the memory. Additionally, or alternatively, the chip may include electronics hardware such as digital circuits, analog circuits, or a combination thereof, which are configured to implement the operations as described herein, including processing of information to generate and transmit wireless signals, to receive and decode wireless signals, or both.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates NPCA Primary Channel and Secondary Channel Access Overview.

FIG. 2A illustrates one approach for switching to NPCA primary channel.

FIG. 2B illustrates another approach for switching to NPCA primary channel.

FIG. 3A illustrates a channel mismatch scenario between an AP and an associated STA, caused by lack of coordination.

FIG. 3B illustrates another channel mismatch scenario between an AP and an associated STA, caused by lack of coordination.

FIG. 4 illustrates grouping of STAs with different channel switching delay requirements.

FIG. 5 illustrates a coordinated NPCA scheme, according to an embodiment.

FIG. 6 illustrates inter-BSS NPCA coordination, according to an embodiment.

FIG. 7 illustrates the encoding of the AID12 subfield, according to an embodiment.

FIG. 8 illustrates the encoding of NPCA switching mode, according to an embodiment.

FIG. 9 illustrates a procedure for Co-NPCA TXOP sharing, according to an embodiment.

FIG. 10 illustrates a trigger frame format, according to an embodiment.

FIG. 11 illustrates a Common Info field format, according to an embodiment.

FIG. 12 illustrates the encoding of the Trigger Type subfield, according to an embodiment.

FIG. 13 illustrates a Trigger Dependent User Info subfield format, according to an embodiment.

FIG. 14 illustrates a block acknowledgement request (BAR) Control field, according to an embodiment.

FIG. 15 illustrates the encoding for BlockAckReq frame variant encoding(11ax).

FIG. 16 illustrates an updated encoding for the BlockAckReq frame variant, according to an embodiment.

FIG. 17 illustrates a BAR information field, according to an embodiment.

FIG. 18 illustrates a Co-NPCA control response frame, according to an embedment.

FIG. 19 illustrates an associated identifier (AID) TID Info subfield, according to an embodiment.

FIG. 20 illustrates the encoding for the AID TID Info subfield, according to an embodiment.

FIG. 21 illustrates the breakdown of a Per AID TID Info field in a Co-NPCA control frame, according to an embodiment.

FIG. 22 illustrates an example Co-NPCA control response frame, according to an embodiment.

FIG. 23 illustrates another example Co-NPCA control response frame, according to an embodiment.

FIG. 24 illustrates another example of the Co-NPCA control response frame, according to an embodiment.

FIG. 25 illustrates another example of the Co-NPCA control response frame, according to an embodiment.

FIG. 26 illustrates an apparatus, such as an IEEE 802.11 device, that may perform any or all of operations of the methods and features explicitly or implicitly described herein, according to different aspects of the present disclosure.

FIG. 27 illustrates a communication system, according to an embodiment of the present disclosure.

FIG. 28A illustrates an example of an apparatus, according to an embodiment of the present disclosure.

FIG. 28B illustrates another example of an apparatus, according to an embodiment of the present disclosure.

FIG. 29 illustrates an inter-BSS coordination method according to an embodiment.

FIG. 30 illustrates an intra-BSS coordination method according to an embodiment.

FIG. 31 illustrates a method for coordinating the sharing of TXOP, according to an embodiment.

It will be noted that throughout the appended drawings, like features are identified by like reference numerals.

### DETAILED DESCRIPTION

Embodiments of the present disclosure provide apparatus, methods and systems for coordinated non-primary channel access. According to an aspect, an inter-BSS coordination method is provided that involves communication between two or more APs in OBSSs to manage NPCA. In this method, a first AP sends a message to a second AP or some other APs requesting its/them participation in NPCA coordination, including details such as the NPCA primary channel location and bandwidth. The second AP or other APs respond(s) with a confirmation message that includes their NPCA parameters. Additionally, the first AP can send recommended NPCA parameters, and the second AP/other APs in NPCA coordination may accept, reject, or propose alternatives. This method may ensure efficient NPCA operation by enabling APs to align on NPCA parameters and optimize channel use in overlapping BSSs. The method may also ensure that each coordinated AP operates on an NPCA primary channel with a low probability of OBSS interference with the NPCA primary channel of a neighboring OBSS when both are operating over their NPCA primary channels at the same time.

According to another aspect, an intra-BSS coordination method is provided that manages NPCA within a single BSS by handling channel switching delays and NPCA switching modes. In this method, an AP sends a message to an associated STA indicating the location and bandwidth of the NPCA primary channel and the configured NPCA switching mode. A STA as used herein may refer to a non-AP STA where appropriate. The associated STA then responds with information based on the NPCA primary channel location, the information indicating an NPCA channel switching delay time and an NPCA channel switching back delay time per BSS. The NPCA channel switching delay may indicate a first time or duration for the associated STA (a non-AP STA) to switch from its primary channel to the NPCA primary channel. The NPCA channel switching back delay time may indicate a second time or duration for the associated STA to switch back from the NPCA primary channel to its primary channel. This method may help the AP in optimizing channel access within the BSS by aligning the NPCA operation with the delay characteristics of the associated non-AP STAs.

According to another aspect, a TXOP sharing coordination method is provided for managing TXOP between APs participating in the Co-NPCA (e.g., where the APs are in a same Co-NPCA group or C-NPCA group). In some embodiments, the TXOP sharing AP may implement a conservative Clear Channel Assessment (CCA) mechanism on the NPCA primary channels for the shared APs. Based on the result of the CCA check, the TXOP sharing AP may decide which AP in the Co-NPCA group to share its TXOP with, thereby reducing the risk of medium synchronization loss for the shared APs. The method also involves a first AP receiving a request from a second AP to switch to an NPCA primary channel and sending an acknowledgment in response. This request may be part of a trigger frame, which includes information on TXOP duration and an indication to the received AP to switch to the NPCA primary channel. The first AP also sends a trigger frame to associated STAs to indicate the channel switch and manage NPCA parameters. This method may enhance TXOP utilization and coordination by ensuring that channel switching and TXOP sharing are efficiently managed across APs. The method may provide further features related to the coordination of channel switching between APs and associated STAs, as described in the embodiments herein. For example, in some embodiments, the trigger frame sent to the associated STAs may be included in a multi-STA BA frame. In some embodiments, the multi-STA BA includes multiple “Per AID TID Info” fields. Some of these fields may provide associated STAs with NPCA switching parameters, introducing zero, one, or two fields for intermediate FCS based on the channel switching delay requirements for the transitioning STAs. In some embodiments and one “Per AID TID Info” field is designated for acknowledging the Co-NPCA control frame sent by the second AP.

For any 802.11 transmission (20/40/80/160/320 MHz), the primary 20 MHz channel needs to be idle to access a wideband channel (>20 MHz). Additionally, if the primary channel is busy, a STA cannot transmit on any idle secondary channels. This approach is not the most efficient use of the <7 GHz bands, particularly for 160/320 MHz channels.

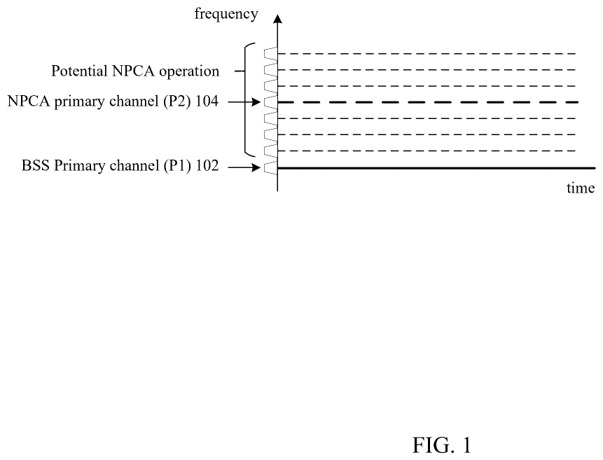

To meet the throughput and latency requirements outlined in the UHR Project Authorization Request (PAR) and to further optimize channel utilization and manage overlapping basic service set (OBSS) interference, NPCA was proposed as a potential method. According to an approved motion, IEEE 802.11bn will define a mode of operation that enables a STA to access the secondary channel while the primary channel is known to be busy due to OBSS traffic or other to-be-defined (TBD) conditions. This mode of operation does not assume that the STA is capable of detecting or decoding a frame and obtaining network allocation vector (NAV) information of the secondary channel concurrently with the primary channel. FIG. 1 illustrates NPCA Primary Channel and Secondary Channel Access Overview. A BSS may have a single NPCA primary channel 104 on which the STA contends while the primary channel 102 of the BSS is known to be busy due to OBSS traffic or other TBD conditions.

To manage the complexity of the NPCA operation, the approved motion limits the number of secondary channels on which a STA can contend while the primary channel 102 is busy to a single NPCA primary channel 104. Access to the NPCA primary channel will follow the same Point Coordination Function Interframe Space (PIFS) rules defined in the baseline. The access point (AP) is responsible for announcing the location of the NPCA primary channel and the NPCA channel bandwidth.

NPCA has been proposed in several contributions that address the problem statement, design principles, high-level concepts, various options, and simulation results. Although there are differences in the details of these proposals, they align on the high-level concept of enabling NPCA while the primary channel 102 is busy.

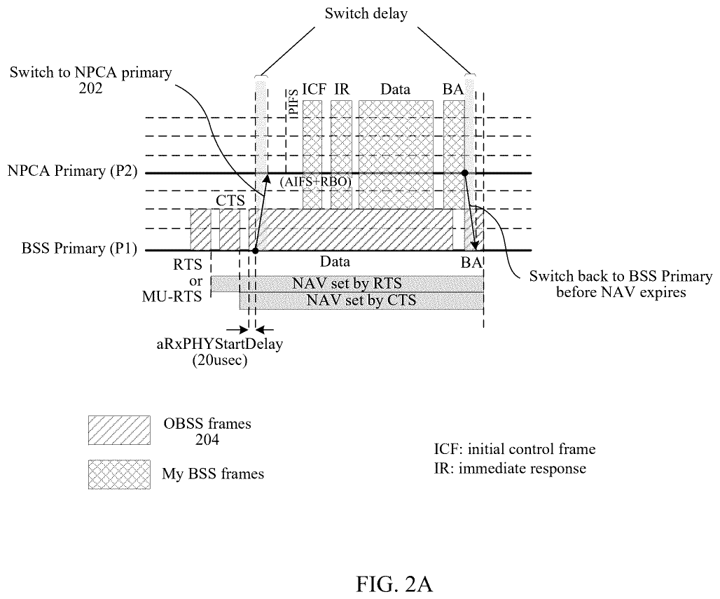

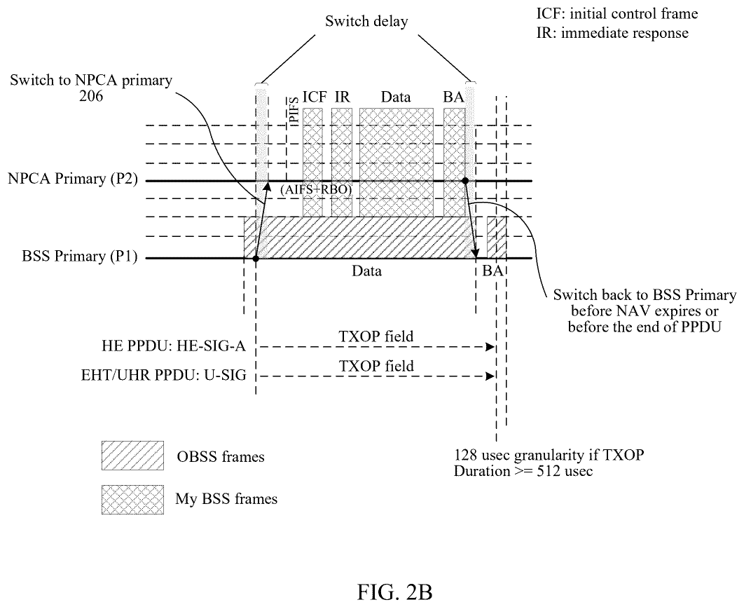

Existing contributions suggest that AP and non-AP STAs should switch to the NPCA primary channel 104 under specific conditions. One approach involves switching after detecting an OBSS control frame exchange, such as multi-user request-to-send (MU-RTS)/clear-to-send (CTS). This method is straightforward but may miss opportunities if the TXOP does not begin with a control frame exchange. FIG. 2A illustrates one approach to switching to NPCA primary channel. As illustrated, the switching 202 is done after detecting the OBSS control frame 204 exchange.

FIG. 2B illustrates another approach for switching to NPCA primary channel. Another approach is to switch 206 based on detecting the PHY header information of an OBSS PPDU. This method covers frame exchanges that do not start with a control frame exchange but requires defining rules for different types of OBSS PPDUs.

For example, in HE PPDU, the HE-SIG-A field carries the BSS Color, Bandwidth, and TXOP fields. The BSS Color is used to detect inter-BSS PPDUs, the Bandwidth field indicates the PPDU's bandwidth, and the TXOP field sets the duration of the NPCA operation on the NPCA primary/secondary channels, with TXOP duration values having a 128 μs granularity for TXOP durations of 512 μs or more. In EHT/UHR PPDUs, the U-SIG field carries similar information (the BSS Color, Bandwidth, and TXOP fields), with the same usage as in HE PPDUs. For VHT PPDUs, the VHT-SIG-A field contains the BW, Group ID, and Partial AID fields. The Group ID and Partial AID fields help detect inter-BSS PPDUs (i.e., OBSS PPDU), and the BW field indicates the bandwidth of the PPDU.

The LENGTH field of the L-SIG field may be used to set the duration of the NPCA operation on the NPCA primary/secondary channels but does not provide TXOP information. For Non-HT or HT PPDUs, the PHY preamble does not contain information to detect inter-BSS PPDUs or the duration. Obtaining this information generally requires decoding the MAC header, which is problematic as the timing of MAC header information availability is implementation-dependent and requires checking the FCS at the end of the PPDU.

As a result, when switching is based on the PHY preamble of an OBSS PPDU, it has been suggested that AP and non-AP STAs should switch to the NPCA primary channel after detecting HE/EHT/UHR PPDUs that contain the necessary information (OBSS, BW, TXOP) for NPCA operation (i.e., after detecting inter-BSS PPDU).

Coordination among APs in the OBSSs and between APs and their associated STAs is often insufficient, making NPCA unreliable and inefficient in several scenarios. Not all UHR STAs in the BSS will transition to the NPCA primary channel, as hidden APs or non-AP STAs may be unable to detect interference from neighboring OBSSs. This can lead to various issues.

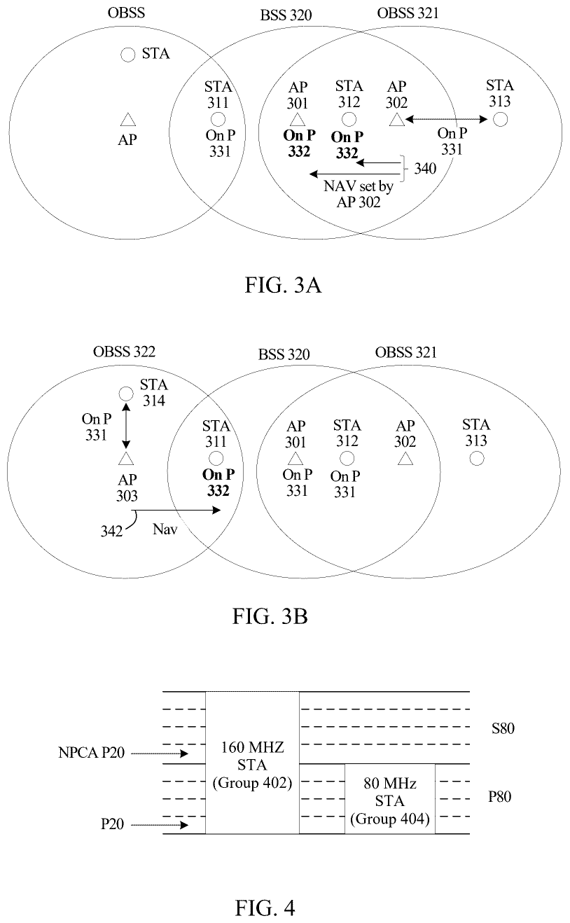

For instance, the AP may operate on the NPCA primary channel while the STA remains on the primary channel as shown in FIG. 3A. FIG. 3A illustrates a channel mismatch scenario between an AP and an associated STA, caused by lack of coordination. In this example, AP 301 and STA 312 in BSS 320 might transition to the NPCA primary channel (P 332) after detecting or hearing OBSS 321 interference 340 and successfully exchange frames. However, STA 311 may remain on the primary channel (P 331) due to being out of range from AP 302 and, therefore, unaware of OBSS 321 interference 340 (i.e., AP 302 and STA 313 communicating on primary channel 331). In this scenario, STA 311 may attempt to transmit to AP 301 on P 331, but AP 301 is no longer active on the primary channel 331, resulting in a lack of response and communication disruptions. Conversely, AP 301 might try to communicate with STA 311 on P 332, but STA 311 has not yet moved or switched to that channel, highlighting the challenge of APs being unaware of the STAs'channel movements.

Another problem that may arise due to lack of coordination is when a STA moves to the NPCA primary channel while the AP remains on the primary channel, as shown in FIG. 3B. FIG. 3B illustrates another channel mismatch scenario between an AP and an associated STA, caused by lack of coordination. As shown, AP 301 and STA 312 in BSS 320 are positioned far from AP 303 in OBSS 322 and are unable to detect interference 342 from OBSS2 (AP 303 and STA 314 communicating on primary channel 331). However, STA 311 can detect or hear the interference 342 on P 331. Consequently, AP 301 and STA 312 remain on the primary channel P 331, while STA 311 transitions to the NPCA primary channel P 332. This misalignment can lead to communication failure. For instance, AP 301 might attempt to transmit to STA 311 on P 331 but will not receive a response as STA 311 is on P 332, similar to when a STA is blocked by OBSS interference. Similarly, STA 311 may try to transmit to AP 301 on P 332 but will not receive a response because AP 301 is on P 331, indicating a mismatch in channel usage between the STA and AP.

Another challenge related to NPCA switching is the impact of the NPCA primary channel's location on the channel switching delay time, which can create coordination and management difficulties. The switching delay can vary depending on whether the NPCA primary channel is within or outside a non-AP STA's operating bandwidth. This delay time can be used to categorize non-AP STAs into groups as shown in FIG. 4. FIG. 4 illustrates grouping of non-AP STA(s) with different channel switching delay requirements. A first group 402 may refer to STA(s) with low channel switching delay requirements because the NPCA primary channel is within their operating bandwidth. A second group 404 may refer to non-AP STA(s) with high channel switching delay requirements, as the NPCA primary channel is outside their operating bandwidth. This disparity in switching delays complicates efficient coordination between APs and STAs.

Furthermore, UHR STAs with NPCA-enabled capabilities may unnecessarily switch to the NPCA primary channel upon detecting inter-OBSS interference, regardless of their immediate communication needs, only to return to the primary channel at the end of the OBSS TXOP duration. This excessive channel switching may lead to increased power consumption without providing any performance benefits.

Embodiments may address one or more limitations of existing NPCA mechanisms that hinder their effectiveness in improving Wi-Fi™ network performance. Some embodiments may provide a coordinated approach among APs and STAs in OBSS environments. Without coordination, inconsistent channel access, reduced spectrum utilization, and increased interference can occur. Some embodiments may address the hidden node problem as described in reference to FIGS. 3A and 3B, where a node (e.g., an AP or a STA) is unable to detect interference from neighboring OBSSs, which can result in collisions and reduced network throughput.

Some embodiments may provide improved channel switching mechanisms to minimize unnecessary channel transitions between primary and NPCA primary channels, reducing excessive power and enhancing network efficiency. Some embodiments may accommodate varied channel switching delay requirements to support STAs with varying capabilities and requirements for channel switching. Some embodiments may provide coordination among nodes to handle unpredictable channel access behaviors and patterns, which may improve network performance.

Embodiments may provide a Coordinated Non-Primary Channel Access (Co-NPCA or C-NPCA) mechanism to address one or more limitations of traditional NPCA. In some embodiments, an intra-BSS and inter-BSS cooperative framework may be established to improve channel utilization.

In some embodiments, a multi-access point (MAP) Co-NPCA group may be formed, where APs within multiple OBSSs cooperate to coordinate channel access more effectively. In some embodiments, a designated AP may share its TXOP with other group members, triggering them to switch to their respective NPCA primary channels, which facilitate efficient use of the spectrum.

In some embodiments, Co-NPCA control frames are exchanged to facilitate coordinated channel switching between the AP and its associated STAs within the BSS. These control frames enable synchronization and reduce the likelihood of collisions after channel transitions.

Some embodiment may accommodate diverse STA switching delay requirements, ensuring that associated STAs complete their transition to the NPCA primary channel at the same time, regardless of their individual capabilities. Some embodiments may optimize power consumption by minimizing unnecessary channel switching. Some embodiments may selectively trigger STA transitions when immediate communication needs require it.

Through one or more embodiments described herein, the Co-NPCA mechanism may enhance network performance, manage interference, and improve overall system efficiency.

As may be appreciated, one or more embodiments may contribute to the standardization of next generation of IEEE 802.11bn for non-primary channel access. Some embodiments may apply to Wi-Fi™ APs and STAs with non-primary channel access capabilities, such as Wi-Fi™ 8 APs or devices including future devices.

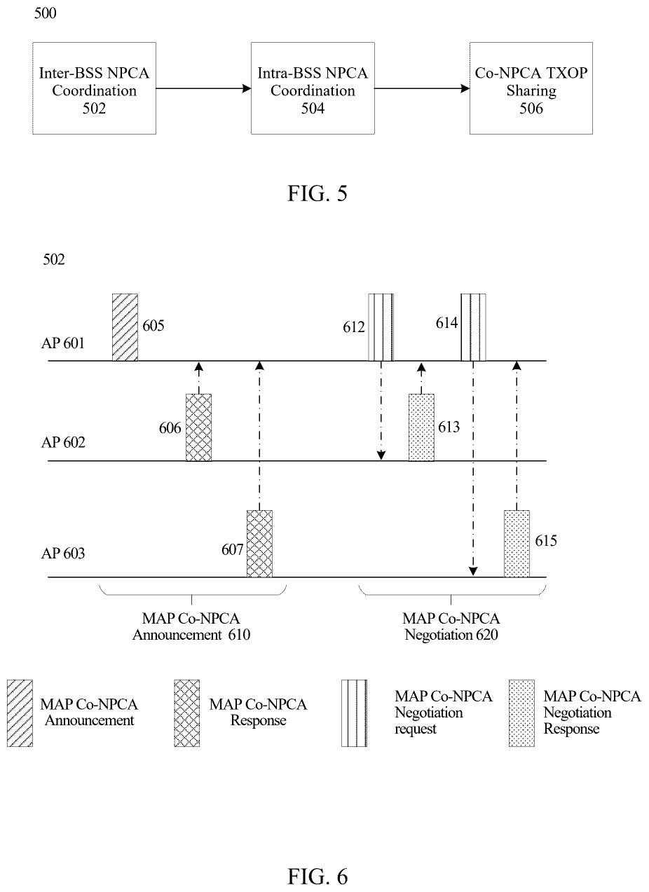

In some embodiments, coordination among APs within OBSSs and between APs and their associated non-AP STAs within their BSSs may address the challenges associated with NPCA. According to some embodiments, a coordinated NPCA scheme 500 is provided, which includes several components. FIG. 5 illustrates a coordinated NPCA scheme, according to an embodiment. The coordinated NPCA scheme 500 includes an inter-BSS NPCA coordination 502. This component 502 involves coordinating NPCA activities among APs in different OBSSs to optimize channel usage and minimize OBSS interference. In some embodiments, this is followed by intra-BSS NPCA coordination 504, which involves further coordination operations within a single BSS to enhance channel access and reduce conflicts among non-AP STAs. Additionally, some embodiments introduce Co-NPCA TXOP sharing 506, where TXOPs are shared among APs within the Co-NPCA group and STAs to facilitate synchronized transitions to NPCA primary channels. By implementing one or more components, the coordinated NPCA scheme 500 aims to improve efficiency and address the limitations of existing mechanisms.

FIG. 6 illustrates inter-BSS NPCA coordination, according to an embodiment. The inter-BSS NPCA coordination 502 includes two phases: a MAP Co-NPCA announcement phase 610 and a MAP Co-NPCA negotiation phase 620.

In some embodiments, during the MAP Co-NPCA announcement phase 610, the coordinating AP 601 identifies one or more other APs 602 and 603 in one or more neighboring OBSSs that are willing to participate in an NPCA coordination. The coordinating AP may use aperiodic or periodic reports from itself and its associated STAs, detailing the received Beacon power levels of neighboring interfering APs, to decide which APs to invite for participation in an NPCA coordination. During this phase, the respective NPCA parameters for each AP (e.g., NPCA primary channel location and bandwidth, BSS operating bandwidth, maximum NPCA channel switching delay per BSS . . . , etc.) can be announced during this phase. According to an embodiment, the coordinating AP sends to each of the one or more other APs 602 and 603 a request 605 to participate in an NPCA coordination.

In some embodiments, if a neighboring AP 602 or 603 is willing and prepared to participate in the NPCA coordination, it can inform the coordinating AP 601 by responding to the announcement received from the coordinating AP. For example, each AP 602 and 603 may send a response 606 and 607, respectively, to AP 601 indicating a willingness to participate in the NPCA coordination. In some embodiments, the response message 606 or 607 confirms the participation in the NPCA coordination. Each of the response 606 and 607 may include NPCA parameters, indicating one or more of: an NPCA primary channel location, an NPCA primary channel bandwidth, an associated BSS operating bandwidth, and a maximum NPCA channel switching delay per BSS. The maximum NPCA channel switching delay may indicate a maximum time or duration for a non-AP STA associated with the neighboring AP to switch from a primary channel to the NPCA primary channel.

In some embodiments, the MAP Co-NPCA announcement phase 610 forms a Co-NPCA group which may also be referred to as a MAP Co-NPCA group, an NPCA coordination group, or a coordinated group, depending on the specific implementation.

In some embodiments, during the MAP Co-NPCA negotiation phase 620, NPCA parameters for MAP coordination are decided among the participating APs. In some embodiments, the coordinating AP 601 sends an NPCA coordination request message 612 and 614 to the other one or more APs 602 and 603 in the NPCA coordination group, along with recommended NPCA parameters for each of the coordinated APs 602 and 603 if needed. In some embodiments, the recommended NPCA parameters includes a recommended NPCA primary channel. The NPCA coordination request may ensure that each coordinated AP operates on a NPCA primary channel with a low probability of OBSS interference with the NPCA primary channel of a neighboring OBSS when both are operating over their NPCA primary channels at the same time.

In some embodiments, upon receiving the request, the coordinated AP 602 and 603 accepts the recommended NPCA parameters by sending an MAP Co-NPCA negotiation response 613 and 615, respectively. In some embodiments, if a coordinated AP accepts the new recommended NPCA parameters, the coordinated AP informs the coordinating AP 601 with the updated maximum NPCA channel switching delay per its BSS via a response, such as an MAP Co-NPCA negotiation response. In some embodiments, the coordinated AP 602 and 603 rejects the recommended NPCA parameters. In some embodiments, the coordinated AP 602 and 603 suggests an alternative set of NPCA parameters indicating an alternative NPCA primary channel via the response 613 and 615.

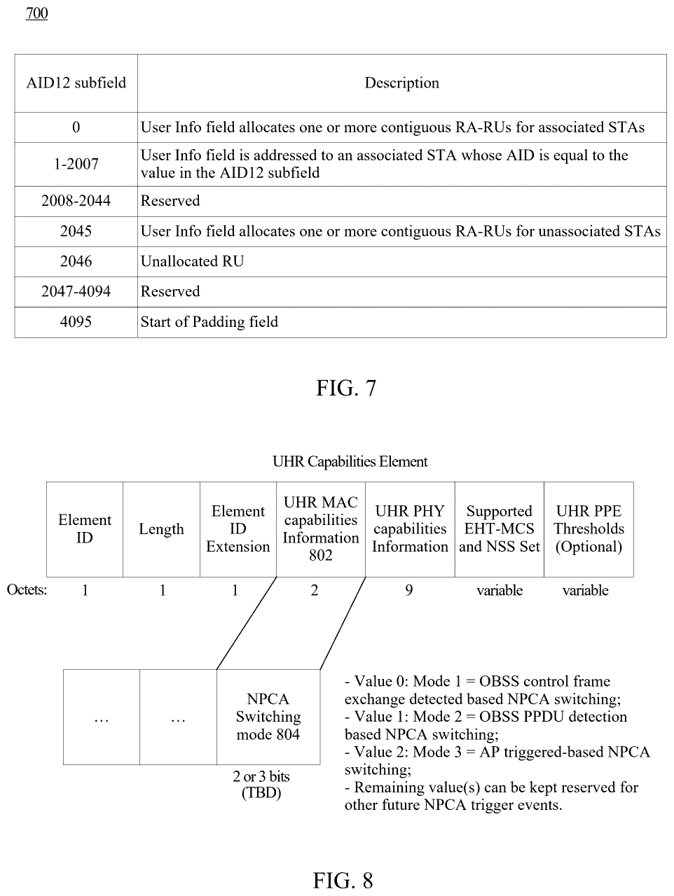

In some embodiments, the inter-BSS NPCA coordination phase 502 further involves the coordinating AP 601 assigning an AP ID to itself and each coordinated AP 602 and 603 in the Co-NPCA coordination group. In some embodiments, this AP ID can be 11 or 12 bits or other appropriate sizes. In some embodiments, the AP ID is based on the AID 12 subfield, as illustrated in FIG. 7. FIG. 7 illustrates the encoding of the AID12 subfield, according to an embodiment. The AID12 subfield encoding 700 may adhere to the IEEE 802.11ax standard. In some embodiments, the AP ID is set to a value within the range of 1 to 2006.

The range of values from 1-2006 for the AID12 subfield is typically used for identifying associated non-AP STAs. Therefore, to ensure that the assigned AP ID is unique and does not overlap with the AID of its associated STAs, in some embodiments, the AP ID is set outside the associated STAs's AID range (AP ID>2007). In some embodiments, the AP ID is selected from the reserved range between 2008 and 2044 or between 2047 and 4094, as indicated.

In some embodiments, the MAP Co-NPCA announcement and negotiation messages can be exchanged between the coordinating and coordinated APs over their common primary channel using Public Action frames by repurposing one or more of the reserved values in the range of 51 to 57 or 61 to 255 within the Public Action field value.

In some embodiments, the intra-BSS NPCA Coordination 504 involves the associating AP announcing the location and bandwidth of the NPCA primary channel to one or more non-AP STA(s) (UHR non-AP STA) within its BSS. For example, the AP may send a message to one or more associated non-AP STAs, the message indicating a location and a bandwidth of the NPCA primary channel.

In some embodiments, the AP announces a unified NPCA switching criteria for all non-AP UHR STAs within its BSS. In some embodiments, this criterion includes one or more modes. In Mode 1, the STA switches to the NPCA primary channel after detecting an inter-OBSS control frame exchange. In Mode 2, the STA switches to the NPCA primary channel upon detecting an inter-OBSS PPDU. In some embodiments, in Mode 3, the STA switches to the NPCA primary channel when triggered by the serving AP through a control frame (e.g., a control response frame or trigger frame).

In some embodiments, the Co-NPCA scheme is based on the AP-triggered NPCA switching, Mode 3, to address the hidden node problem. In some embodiments, non-AP STAs inform their associating AP of their respective NPCA channel switching delay time and NPCA channel switching back delay time, which depend on the location of the selected NPCA primary channel. The NPCA channel switching delay may refer to the time the non-AP STA can take to switch from its primary channel to the NPCA primary channel. The NPCA channel switching back delay time is the time the non-AP STA can take to switch back from the NPCA primary channel to its primary channel.

In some embodiments, the AP may announce the maximum NPCA channel switching delay per BSS to all associated non-AP STAs within the BSS. All STAs may adhere to this maximum delay value and refrain from initiating any communication over the NPCA primary channel until the specified time has elapsed.

FIG. 8 illustrates the encoding of NPCA switching mode, according to an embodiment. In some embodiments, the NPCA switching criteria, which include specifying a mode for NPCA switching, can be encoded using an UHR MAC capabilities information field 802 of a UHR Capabilities Element. In some embodiments, the NPCA switching criteria is included in an UHR Capabilities Element that can be transmitted using one or more of: a beacon frame, and a (re) association request/response frames. The encoding may use 2 or 3 bits, or other appropriate sizes, for representing the NPCA switching mode. In some embodiments, an NPCA switching mode subfield 804 is employed to indicate the specific NPCA switching mode. This subfield 804 can be set to a value that corresponds to the indicated NPCA switching mode, as illustrated.

In some embodiments, the NPCA switching criteria may be included in a separate NPCA Capability Element that can be transmitted using a beacon frame and in the (re) association request/response frames.

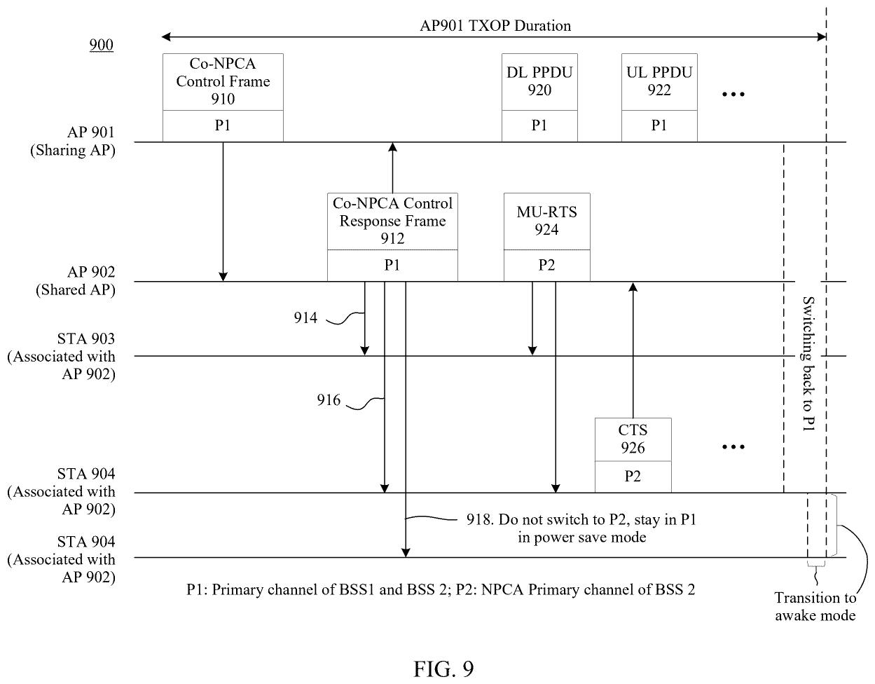

In some embodiments, Co-NPCA TXOP sharing 506 includes procedure 900 for coordinating NPCA among AP members and associated STAs. FIG. 9 illustrates a procedure for Co-NPCA TXOP sharing, according to an embodiment. In an embodiment, the sharing AP 901 and shared AP 902 are part of an MAP Co-NPCA group.

In some embodiments, when an AP 901 in the MAP Co-NPCA group obtains a TXOP, it shares the TXOP with other coordinated APs 902 included in the MAP Co-NPCA group by sending a Co-NPCA control frame 910 (a Co-NPCA initial control frame (ICF)) to promote them to switch to their respective NPCA primary channels. The Co-NPCA control frame 910 can be of any appropriate frame type, such as an MU-RTS frame, BSRP frame, a multi-user block acknowledgement request (MU-BAR) frame type, a BAR frame type, or a new trigger frame type.

In response, the shared APs 902 send a control response frame 912 (a Co-NPCA control response frame) to acknowledge receipt of the Co-NPCA control frame 910. In some embodiments, the control response frame 912 can also be used to trigger 914 and 916 the associated non-AP STAs 903 and 904 to switch to the NPCA primary channel P2, addressing the hidden node problem. For example, AP 902 can send a trigger frame 914 and 916 to associated non-AP STAs 903 and 904 to indicate the switch to the NPCA primary channel P2.

In some embodiments, the control response frame 912 triggers 918 an associated non-AP STA 905 to remain on the primary channel (i.e., not switch to the NPCA primary channel) in power save-mode if there is no immediate communication needs or due to the limited shared TXOP duration. In some embodiments, the Co-NPCA control response frame 912 can be a multi-STA block acknowledgement (BA) and may also handle responses to BSRP, MU-BAR and MU-RTS Trigger frames.

The sharing AP 901 may continue communication 920 and 922 on the primary channel P1 for the duration of the TXOP, while the shared AP 902 and its associated STA 903 and 904 communicate 924 and 926 on the NPCA primary channel P2. Prior to the end of TXOP duration, AP 902, non-AP STA 903 and non-AP STA 904 may switch back to their primary channel P1, and non-AP STA 905 transitions to awake mode (exits power-save mode), as it was not required to switch to P2 due to a lack of immediate communication needs or limited shared TXOP duration.

In some embodiments, the design of the control response frame 912 facilitates transitioning one or more UHR non-AP STAs to the NPCA primary channel based on immediate communications needs, helping to save power by reducing unnecessary channel switching.

In some embodiments, the design of the control response frame 912 may account for varying channel switching delay requirements among transitioning non-AP STAs, ensuring they all complete the switch to the NPCA primary channel at the same time.

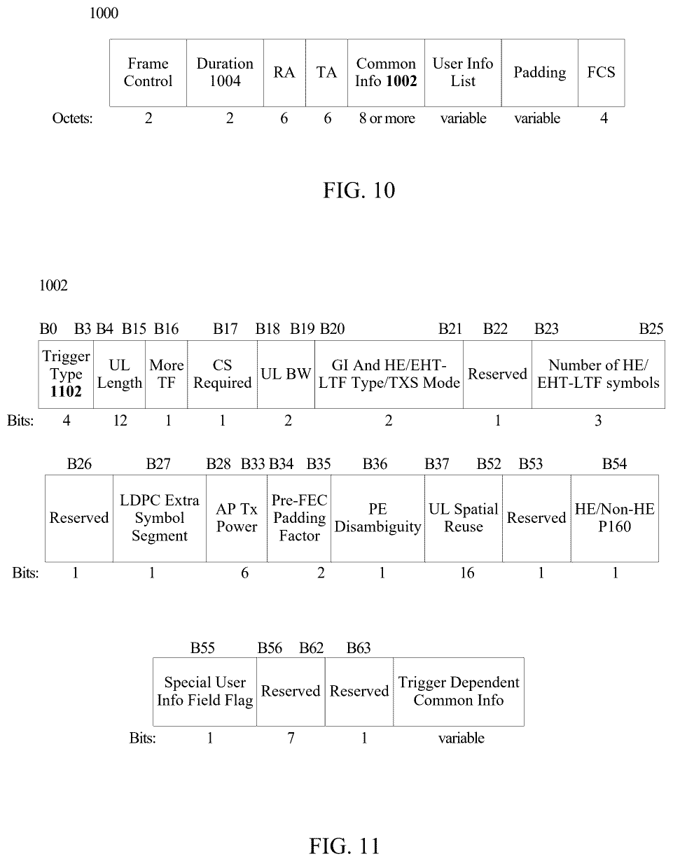

FIG. 10 illustrates a trigger frame format, according to an embodiment. In some embodiments, the Co-NPCA initial control frame 910 is a trigger frame 1000 sent by the TXOP sharing AP 901 to trigger all shared APs 902 in the neighboring OBSS that are part of the Co-NPCA group to switch to their NPCA primary channel.

The format of the trigger frame 1000 is shown. The trigger frame includes one or more fields as shown including a common info field 1002 and a duration field 1004. In some embodiments, the trigger frame format 1000 is based on IEEE 802.11be standard.

FIG. 11 illustrates a Common Info field format, according to an embodiment. The Common Info field format may be based on a UHR variant Common Info field format. The Common Info field format 1002 includes one or more subfields as shown including a Trigger Type subfield 1102. In some embodiments, the type of the trigger frame 910 is indicated based on the value of the Trigger Type subfield 1102 within the Common Info field, as shown.

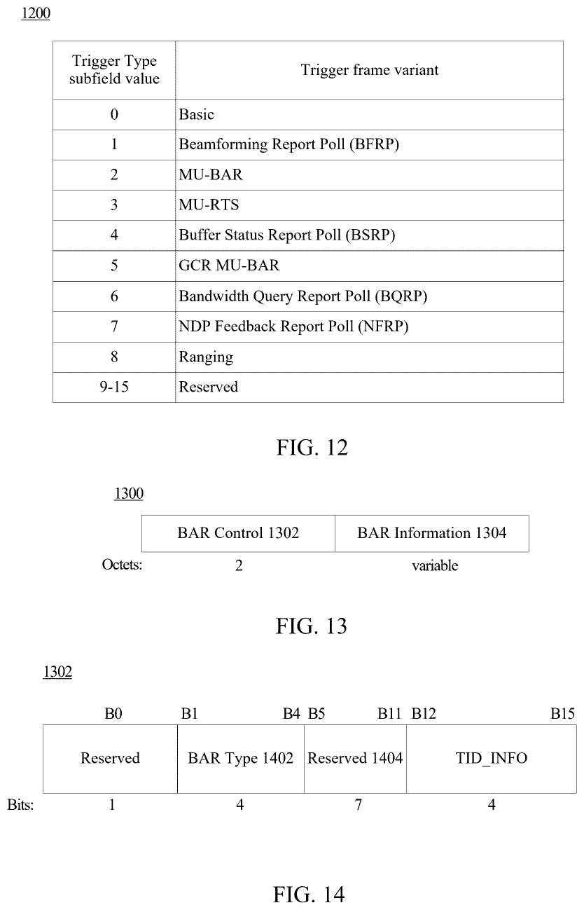

FIG. 12 illustrates the encoding of the Trigger Type subfield, according to an embodiment. In some embodiments, the value of the Trigger Type subfield 1102 is based on table 1200 showing the different encoding of the Trigger Type subfield. In some embodiments, the value of the Trigger Type subfield 1102 is set to indicate an MU-BAR trigger frame variant (e.g., by setting the Trigger Type subfield value to ‘2’), a multi-user request-to-send (MU-RTS) trigger frame (e.g., by setting the Trigger Type subfield value to ‘3’), a buffer status report poll (BSRP) trigger frame (e.g., by setting the Trigger Type subfield value to ‘4’). In some embodiments, a new trigger frame variant may be defined based on setting the value of the Trigger Type subfield 1102 to indicate a reserved value (e.g., a value selected from the range 9 to 15).

In some embodiments, the Co-NPCA ICF 910 is indicated by the Trigger Dependent User Info field of the trigger frame, which may be an MU-BAR trigger frame (e.g., Trigger Type subfield value set to indicate MU-BAR), an MU-RTS trigger frame, a BSRP trigger frame, or the newly defined trigger frame type (e.g., based on using one of the reserved values (9-15) in the Trigger Type subfield). In some embodiments, the Co-NPCA ICF parameters (e.g., TXOP duration) is included in the Trigger Dependent User Info field (or subfield) of the chosen frame type. In some embodiments, the Co-NPCA ICF parameters including TXOP duration is included in a duration field of the trigger frame.

FIG. 13 illustrates a Trigger Dependent User Info subfield format, according to an embodiment. In some embodiments, the Trigger Dependent User Info subfield format 1300 corresponds to the subfield used in the trigger frame, which may an MU-BAR trigger frame, as specified in the 11ax standard, an MU-RTS trigger frame, or a BSRP trigger frame. In some embodiments, the Trigger Dependent User Info subfield format 1300 corresponds to a similar subfield in a trigger frame indicated based on using one of the reserved values (9-15) in the Trigger Type subfield 1102.

In some embodiments, the Co-NPCA ICF 910 is indicated by the Trigger Dependent User Infor field of the MU-BAR trigger frame or a trigger frame indicated based on using one of the reserved values (9-15) in the Trigger Type subfield.

In some embodiments, the Trigger Dependent User Info subfield format 1300 includes a block acknowledgement request (BAR) Control subfield 1302 and a BAR Information subfield 1304 as illustrated.

FIG. 14 illustrates a BAR Control field, according to an embodiment. The BAR Control field 1302 may correspond to the subfield as specified in the 11ax standard. In some embodiments, BAR Control field 1302 includes one or more subfields including a BAR Type subfield 1402, and a reserved subfield 1404.

In some embodiments, the reserved subfield 1404 may be used to indicate Co-NPCA triggering starts. For example, one of the reserved bits (B5-B11) may be used to indicate Co-NPCA triggering starts. In this option, the sharing AP 901 can include its TXOP duration within the Duration field 1004 of the trigger frame 910 or 1000.

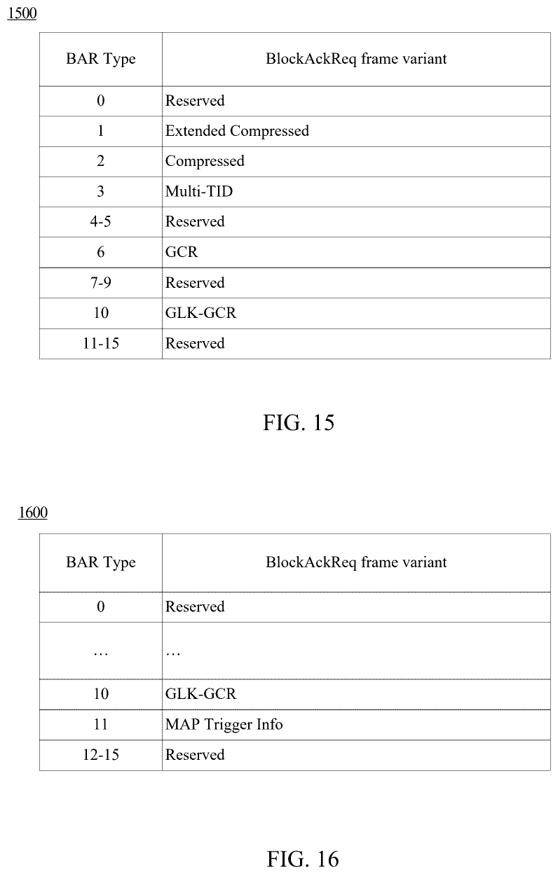

In some embodiments, the BAR Type subfield 1402 is used to indicate Co-NPCA. In some embodiments, the BAR Type subfield 1402 indicates a BlockAckReq frame variant. FIG. 15 illustrates the encoding for BlockAckReq frame variant encoding(11ax).

In some embodiments, the BAR Type subfield 1402 can be used to indicate a frame variant for one or more MAP Cooperation purposes (e.g., Co-NPCA, Coordinated Spatial Reuse (CSR), Coordinated TDMA, Coordinated restricted Target Wake-up Time (C-RTWT), Coordinated Beamforming (C-BF), Coordinated OFDMA (C-OFDMA), . . . , etc.). For example, as shown in table 1500, one of the reserved values (4-5, 7-9, or 11-15) can be used to indicate, via the BAR Type subfield, a frame variant for one or more MAP Cooperation purposes.

FIG. 16 illustrates an updated encoding for the BlockAckReq frame variant, according to an embodiment. Table 1600 illustrates an updated version of BlockAckReq frame variant encoding. As an example, a reserved value of 11 for BAR Type subfield can be used to indicate MAP Trigger Info as the BlockAckReq frame variant. It may be appreciated that other reserved values (4-5, 7-9, or 11-15) can also be similarly used.

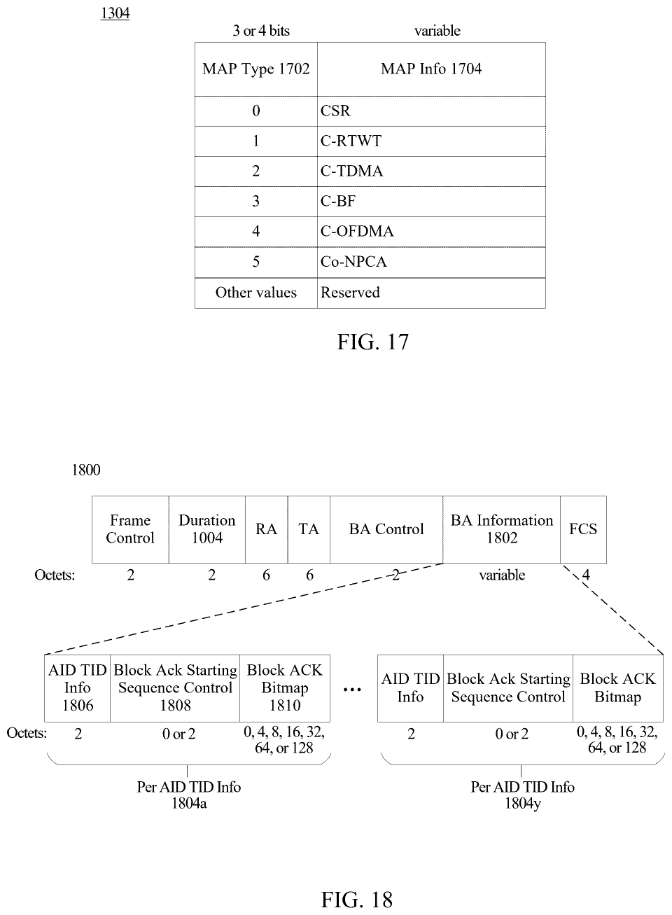

FIG. 17 illustrates a BAR information field, according to an embodiment. In some embodiments, the BAR information field 1304 includes a MAP Type subfield 1702 and a MAP Info subfield 1704. In some embodiments, based on the type of the MAP Type subfield, the MAP Info subfield may have different triggering parameters, as shown.

In some embodiments, the Co-NPCA ICF 910 is indicated by setting the Trigger Type subfield 1102 to a reserved value (e.g., 9 to 15). In some embodiments, the Trigger Type subfield 1102 of the trigger frame is set to any of the reserved values (9-15) to indicate MAP coordination triggering. In such embodiments, the trigger frame includes a Trigger Dependent User Info subfield, similar to the subfield 1300 as described herein.

In some embodiments, the BAR Type subfield 1402 of the BAR Control field 1302 (of the Trigger Dependent User Info 1300) can be set to one of the reserved values (4-5, 7-9, or 11-15) to indicate MAP coordination triggering as described herein. Further, the BAR Information subfield 1304 of the Trigger Dependent User Info field 1300 can be used to define MAP Type and MAP Info subfields 1702 and 1704 as described herein. The MAP Type subfield 1702 may indicate the type of MAP coordination, such as Co-NPCA, or other MAP purposes. The MAP Info subfield 1704 may include one or more parameters related to the MAP coordination.

In some embodiments, the Trigger Type subfield 1102 of the trigger frame is set to any of the reserved values (9-15) to indicate Co-NPCA triggering. In such embodiments, the trigger frame includes a Trigger Dependent User Info subfield, similar to the subfield 1300 as described herein. In some embodiments, within the Trigger Dependent User Info field of this trigger frame, NPCA triggering information (e.g., NPCA triggering indication and TXOP duration (16 bits), can be included.

In some embodiments, the Co-NPCA control response frame 912 is based on a multi-STA BA frame. FIG. 18 illustrates a Co-NPCA control response frame, according to an embedment. The Co-NPCA control response frame 1800 is similar to the control response frame 912 and is based on a Multi-STA BA frame. In some embodiments, the Co-NPCA control response frame 1800 allows for multiple Per AID TID Info fields, labeled 1804a, . . . 1804y (each referred to as 1804), to be included in a BA Information field 1802.

In some embodiments, the Co-NPCA control response frame 912 or 1800 includes one or more Per AID TID Info fields for indicating one or more of the following: NPCA switching parameters, intermediate FCS, and acknowledgment of the Co-NPCA control frame 910 sent by the sharing AP 901. In some embodiments, one or more Per AID TID Info fields provide associated non-AP STAs with NPCA switching parameters. In some embodiments, the Co-NPCA control response frame 912 includes zero, one, or two fields for intermediate FCS, depending on the channel switching delay requirements for the transitioning non-AP STAs. In some embodiments, each intermediate FCS field is implemented or provided by one Per AID TID Info field. In some embodiments, the Co-NPCA control response frame 912 includes one Per AID TID Info field designated for acknowledging the Co-NPCA control frame 910 sent by the sharing AP.

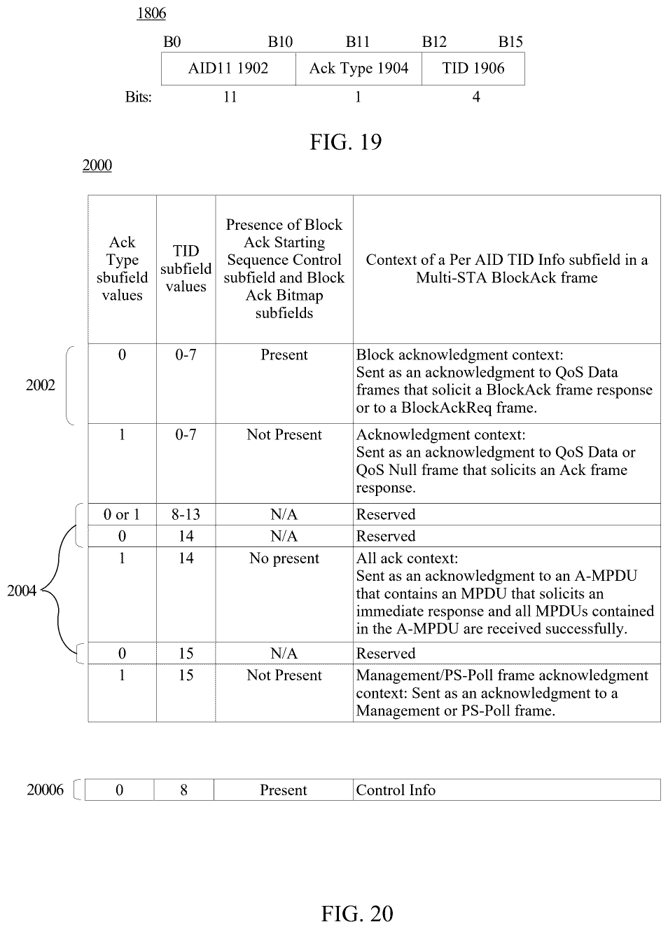

In some embodiments, each Per AID TID Info field 1804 includes an AID TID info subfield 1806, a Block Ack Starting Sequence Control subfield 1808 and a Block Ack Bitmap subfield 1810. FIG. 19 illustrates an AID TID Info subfield, according to an embodiment. The AID TID Info subfield 1806 includes one or more further subfields: AID11 1902 comprising 11 bits, Ack Type 1904 comprising 1 bit, and TID 1906 comprising 4 bits as illustrated.

The AID 11 subfield 1902 may carry the 11 least significant bits (LSBs) of the AID of the non-AP STA for which the Per AID TID Info subfield 1804 is intended. In some embodiments, the format of the Per AID TID Info subfield 1804 depends on the value of the AID11 subfield 1902. In some embodiments, if the multi-STA BA frame (e.g., the Co-NPCA control response frame) is sent to an AP, the AID11 subfield is set to 0. In some embodiments, a value of 2045 in the AID11 subfield is used as an identifier for any unassociated STA. In some embodiments, if the AID11 subfield is set to 2045, then the ACK Type subfield 1904 and TID subfield 1906 are set to 0 and 15, respectively.

In some embodiments, one Per TID Info field 1804 can be set to ACK the Co-NPCA control frame 910, sent by the sharing AP 901. FIG. 20 illustrates the encoding for the AID TID Info subfield, according to an embodiment. Table 2000 may be used to format one or more Per TID Info fields 1804 to indicate an Acknowledgement response 912 to the sharing AP 901. In some embodiments, the AID subfield includes the Sharing AP ID. In some embodiments, the Ack Type subfield 1904 and TID subfield 1906 can be set any combination according to row 2002 to ACK the Co-NPCA control frame, sent by the sharing AP. For example, the Ack Type subfield 1904 can be set to ‘0’ and the TID subfield 1906 can be set to a value in the range 0-7.

In some embodiments, the value of the 1-bit ACK Type subfield 1904 and the 4-bit TID subfield 1906 can be set to indicate if the Per AID TID Info 1804 is sent for Ack, BA, or other control info.

In some embodiments, a setting based on reserved values from rows 2004 can be repurposed to indicate the intended use of the “Per AID TID Info” field for conveying NPCA parameters, accommodating intermediate FCS, or other control info. As an example, Ack Type subfield 1904 can be set to ‘0’ and the TID subfield 1906 can be set to ‘8’ as shown in an example row 2006 for conveying NPCA parameters, accommodating intermediate FCS, or other control info.

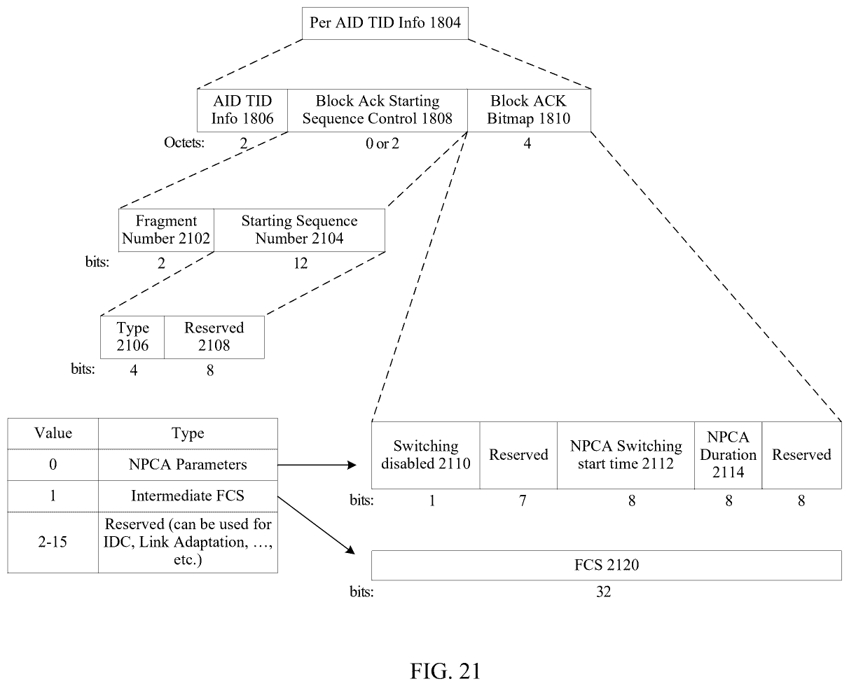

FIG. 21 illustrates the breakdown of a Per AID TID Info field in a Co-NPCA control frame, according to an embodiment. In some embodiments, each Per AID TID Info field 1804 further includes a Block ACK Starting Sequence Control subfield 1808, which can be (re)used to indicant control info. In some embodiments, the Block ACK Starting Sequence Control subfield 1808 includes a Fragment Number subfield 2102 and a Starting Sequence Number subfield 2104. In some embodiments, the Fragment Number subfield 2102 indicates the length of the Block ACK Bitmap subfield 1810. In some embodiments, the Fragment Number subfield 2102 can be used to indicate the length of the control info included within the Block Ack bitmap subfield. In some embodiments, the Staring Sequence Number subfield 2104 is used to indicate the starting sequence number. In some embodiments, the Staring Sequence Number subfield 2104 can be used to indicate the type of control info. In some embodiments, 4 bits (e.g., the first 4 bits) of the Staring Sequence Number subfield 2104 can be used to indicate a type of control info. In some embodiments, the Staring Sequence Number subfield 2104 includes a Type subfield 2106 comprising these 4 bits for indicating a type of control info. In some embodiments, the Type subfield 2106 can be set to: value ‘0’ to indicate NPCA parameters or value ‘1’ to indicate Intermediate FCS. In some embodiments, the values 2 to 15 for Type subfield 2106 can be reserved for other control info, e.g., IDC unavailability periods, link adaptation, etc. In some embodiments, the Staring Sequence Number subfield 2104 includes a reserved subfield 2108 for reserving the remaining 8 bits of the Staring Sequence Number subfield 2104.

In some embodiments, the Block Ack bitmap subfield 1810 is used to indicate info parameters. For example, if the Type subfield value is set 0, indicating NPCA parameters, the Block ACK Bitmap subfield 1810 includes the NPCA parameters Info. In some embodiment, where the Block ACK Bitmap subfield 1810 indicates NPCA parameters, the subfield 1810 includes one or more further subfields for indicating one or more of: whether switching is disabled, NPCA switching start time, NPCA duration, and a reserved subfield. For example, in some embodiments 1 bit of the Block ACK Bitmap subfield 1810 is used to indicate whether switching is disabled via a first subfield 2110. In some embodiments, a value of ‘0’ for the subfield 2110 indicates to switch to the NPCA primary channel, whereas a value of ‘1’ indicates to remain on the primary channel (e.g., do not switch to the NPCA primary channel). In some embodiments, 8 bits of the Block ACK Bitmap subfield 1810 is used to indicate switching start time via a second subfield 2112. In some embodiments, 8 bits of the Block ACK Bitmap subfield 1810 is used to indicate switching duration via a third subfield 2114. In some embodiments, the remaining bits may be reserved for future use.

In some embodiments, if the Type subfield value is set to ‘1’, indicating Intermediate FCS, the Block ACK Bitmap field subfield includes 32 bits FCS 2120.

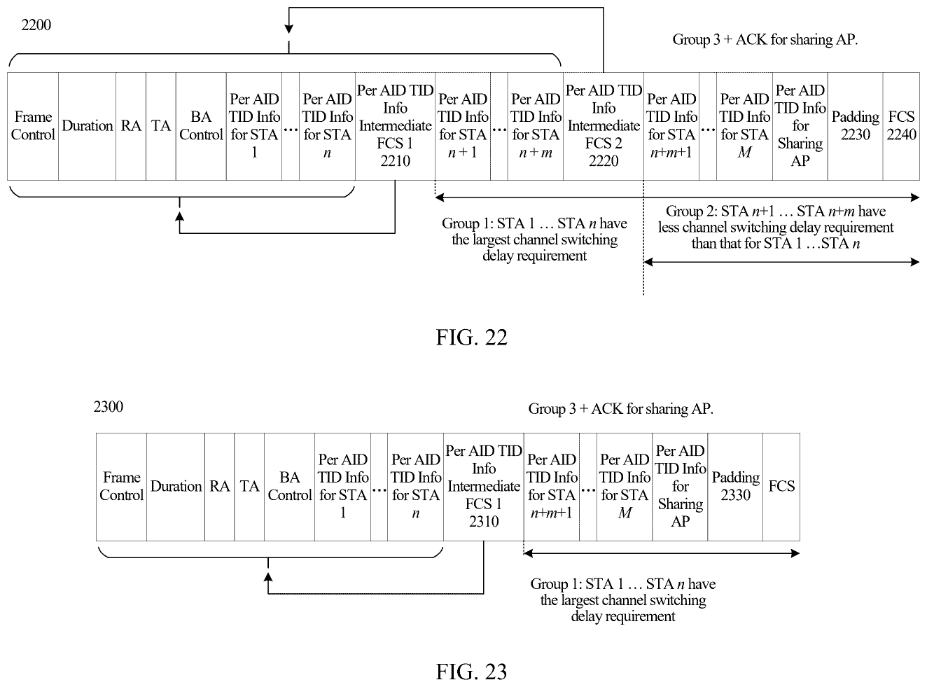

FIG. 22 illustrates another Co-NPCA control response frame, according to an embodiment. In some embodiments, based on the reported NPCA channel switching delay (or channel switching delay) from transitioning STAs, there may be one or more groups of NPCA STAs. The reported NPCA channel switching delay may be based on the location of the NPCA primary channel. The reported NPCA channel switching delay may indicate a time for a non-AP stat to switch from a primary channel to the NPCA primary channel. In some embodiments, based on the reported channel switching delay from transitioning STAs, a first group of STAs with high channel switching delay requirements, referred to as Group 1, may be determined. Group 1 may refer to a group of NPCA non-AP STAs for which the NPCA primary channel is outside of their operating bandwidth, e.g., STA 1 . . . STA n. As illustrated in the control response frame 2200, one Per AID TID Info field is used for each STA in Group 1, and each STA can be selectively triggered to switch to the NPCA primary channel.

In some embodiments, based on the reported channel switching delay from transitioning STAs, a second group of STAs with moderate or low channel switching delay requirements, referred to as Group 2, may be determined. Group 2 may refer to a group of NPCA non-AP STAs for which the NPCA primary channel is within their operating bandwidth, e.g., STA n+1 . . . STA n+m. As illustrated in the control response frame 2200, one Per AID TID Info field is used for each STA in Group 2, and each STA can be selectively triggered to switch to the NPCA primary channel.

In some embodiments, based on the reported channel switching delay from transitioning STAs, a third group of STAs with no or minimal channel switching delay requirements, referred to as Group 3, may be determined, e.g., STA n+m+1 . . . STA M. As illustrated in the control response frame 2200, one Per AID TID Info field is used for each STA in Group 3, and each STA in Group 3 can be selectively triggered to switch to the NPCA primary channel.

In some embodiments, the AP, e.g., AP 902, assigns to each group of STAs a unique group AID. In some embodiments, the group AID may be a value selected from 1 to 2006.

In some embodiment, zero, one or more Per AID TID Info fields are used as Intermediate FCS fields 2210 and 2220 to allow the one or more groups of STAs, e.g., Group 1 and/or Group 2, to complete switching to the NPCA primary channel at the same time.

In some embodiments, when a Per AID TID Info field is used as an Intermediate FCS field, the AID11 subfield indicates the corresponding or associated group AID.

In some embodiments, a padding or dummy user info field 2230 with variable size (depending on the switching delay requirements for Groups 1 and 2) is included at the end of the frame, before the final FCS field 2240, to ensure that all transitioning STAs have sufficient time to complete the channel switch at the same time. This may be necessary, for example, if the intermediate FCS info fields 2210 and 2220 are insufficient to allow all the STAs in the Group 1and/2 to transition.

In some embodiments, the AP may announce the maximum NPCA channel switching delay per BSS to all associated non-AP STAs within the BSS. All STAs may adhere to this maximum delay value and refrain from initiating any communication over the NPCA primary channel until the specified time has elapsed. In this case, no need for using one or more Per AID TID Info field as an Intermediate FCS field.

In some embodiments, based on the value of the 1-bit switching disabled subfield 2110 in the NPCA parameters within the Block Ack Bitmap field, the AP may trigger all UHR non-AP STAs to switch to the NPCA primary channel, or selectively trigger specific ones based on historical traffic patterns, TXOP duration, or immediate communication needs. In some embodiments, to conserve power, non-AP STAs without pending uplink or downlink transmissions remain untriggered and stay on the primary channel, avoiding unnecessary channel switching.

In some embodiments, the Co-NPCA control response frame is designed with flexibility to accommodate varying numbers of STA groups, to allow for improved coordination and communication under different scenarios. In some embodiments, the Co-NPCA control response frame can be tailored to handle one, two, or three groups of STAs (e.g., Groups 1, 2 and/or 3 as previously defined herein), allowing it to efficiently manage STAs with different channel switching delay characteristics. This flexibility enables the control response frame to optimize transitions according to the specific needs of the STAs in each group, ensuring seamless communication and minimizing disruptions during channel switching.

FIG. 23 illustrates an example Co-NPCA control response frame, according to an embodiment. The control response frame 2300 is tailored for scenarios where only Group 1 (STAs with high channel switching delay requirements) and Group 3 (STAs with no or minimal channel switching delay requirements) are present. The response frame 2300 is formatted to handle the distinct characteristics of these two groups while optimizing the coordination and timing of their channel switching activities.

In this embodiment, the control response frame 2300 includes a corresponding Per AID TID Info field for each STA in Group 1 (STA 1 to STA n) and Group 3 (STA n+m+1 to STA M) as illustrated.

To accommodate the high channel switching delay requirements of Group 1, in some embodiments, the control response frame 2300 includes an Intermediate FCS 2310, which provides a designated period for the transition. However, in cases where the Intermediate FCS 2310 alone does not provide sufficient time for all STAs in Group 1 to complete the switch, a Padding field 2330 is included to extend the switching window. This padding may ensure that any remaining non-AP STAs in Group 1 have enough time to complete their transition, preventing communication breakdowns or delays.

In some embodiments, one Per AID TID Info field may be used for all non-AP STAs within a group, e.g., Group 1 or Group 2, to indicate switching to the NPCA primary channel. For example, if all non-AP STAs within Group 1 are to switch to NPCA primary channel, then the AP can use one Per AID TID Info field for group 1 followed by the Per AID TID Info Intermediate FCS 1 field by utilizing the Group 1 AID in the AID field for the two fields. Similarly, if all STAs within Group 2 are to switch to NPCA primary channel, the AP can use one Per AID TID Info field for Group 2 followed by the Per AID TID Info Intermediate FCS 2 field by utilizing the Group 2 AID in the AID field for the two fields.

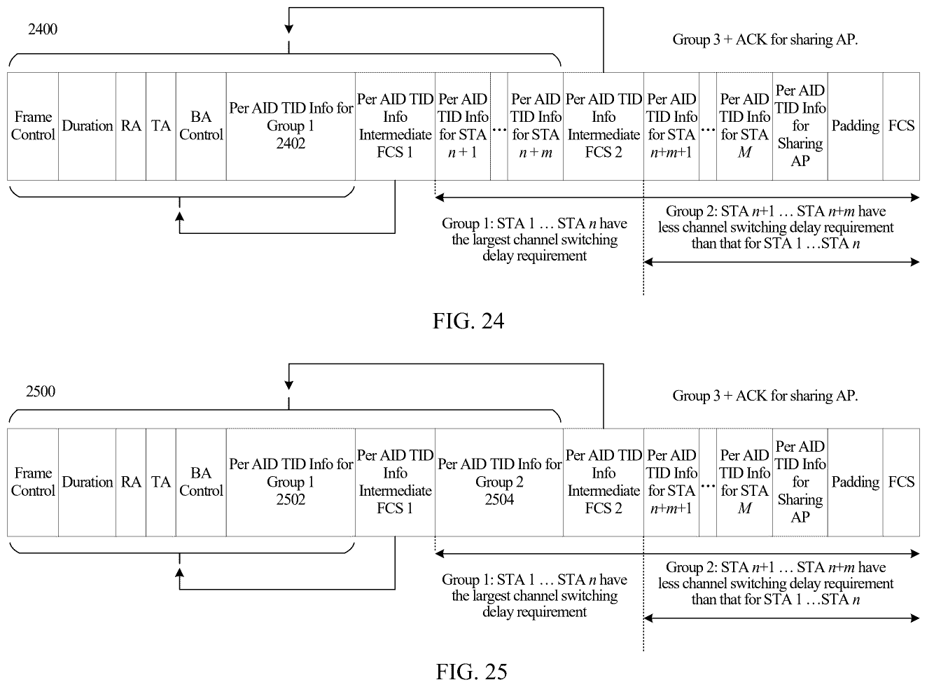

FIG. 24 illustrates another example of the Co-NPCA control response frame, according to an embodiment. In this configuration, all non-AP STAs in Group 1 will switch to the NPCA primary channel, while only a subset of STAs in Group 2 and Group 3 will transition to the NPCA primary channel which may be based on specific communication needs, such as transmission requirements, historical traffic data, or other parameters like power-saving strategies. As a result, the control response frame 2400 includes one Per AID TID Info field 2402 for all STAs in Group 1 to manage their channel switching coordination. Additionally, a separate Per AID TID Info field is allocated for each STA in Groups 2 and 3 allow for selective triggering of STAs to transition to the NPCA primary channel, ensuring that only those non-AP STAs requiring the switch are triggered. This selective channel switching strategy enhances network efficiency by minimizing unnecessary transitions for STAs with no current transmission needs.

FIG. 25 illustrates another example of the Co-NPCA control response frame, according to an embodiment. In this configuration, all non-AP STAs in both Group 1 and Group 2 switch to the NPCA primary channel. In this scenario, the transition to the NPCA primary channel may be necessary for both groups due to their shared requirement for coordinated channel switching, such as when both groups have active communication demands. The control response frame 2500 may be designed to efficiently manage this process by including one Per AID TID Info field 2502, which coordinates the channel switch for all non-AP STAs in Group 1. Similarly, one Per AID TID Info field 2504 is allocated for all non-AP STAs in Group 2.

This structure may ensure that the switching process is streamlined, reducing the need for individual Per AID TID Info fields for each non-AP STA and instead grouping them by their switching requirements. Grouping the STAs may allow for improved use of control signaling while ensuring that all non-AP STAs within each group transition to the NPCA primary channel without conflict.

In some embodiments, systems and methods are provided for the formation of MAP Co-NPCA groups. According to some embodiments, the formation of MAP Co-NPCA groups may enable coordinated channel access among APs in OBSSs, potentially improving overall network efficiency. By creating cooperative groups of APs within OBSSs, embodiments may facilitate coordinated channel usage, which may reduce interference and increase system throughput.

Some embodiments may provide for sharing of TXOP among MAP Co-NPCA group members. According to certain embodiments, this sharing of TXOP may optimize channel utilization by allowing multiple OBSSs to coordinate their access to the NPCA primary channel simultaneously. By sharing TXOP among multiple APs, embodiments may utilize the available spectrum more effectively, which could result in higher data rates and potentially improved network capacity.

Some embodiments provide for an AP-triggered NPCA switching mode. According to an embodiment, this mode may address the hidden node problem described herein by enabling APs to control STA channel switching. Through this mechanism, APs may trigger NPCA channel switching for their associated STAs, which may overcome the limitations of traditional NPCA, where hidden nodes can degrade performance.

In some embodiments, Co-NPCA control frames are used to facilitate coordinated NPCA channel switching. According to some embodiments, these control frames may enable efficient and reliable coordination of NPCA channel switching for both APs and their associated non-AP STAs. The use of control frames may ensure smooth transitions between primary and NPCA primary channels, enhancing coordination among APs and stations.

Some embodiments support or accommodate diverse STA channel switching delay requirements. Embodiments may consider the varying NPCA channel switching delay capabilities of different devices, enabling them to complete the transition to their NPCA primary channel, which may result in improved overall network performance.

In some embodiments, selective triggering of STA channel switching is provided. According to some embodiments, selective triggering may reduce power consumption and improve network efficiency by avoiding unnecessary channel transitions for STAs without pending transmissions.

As noted above, according to an aspect, a Wi-Fi™ 8 (i.e. 8^{th} generation Wi-Fi™ e.g. according to the IEEE 802.11bn standards documents) AP or device (future devices) may be configured according to one or more of methods, features, and embodiments described herein. Embodiments may potentially be applicable to standards subsequent to Wi-Fi™ 8.

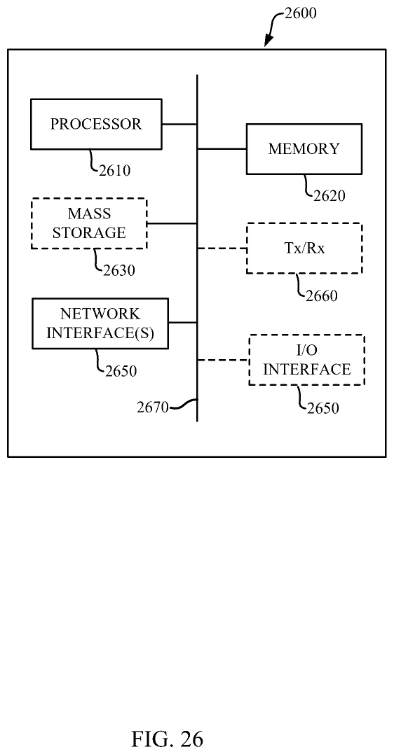

FIG. 26 illustrates an apparatus 2600 that may perform any or all of operations of the methods and features explicitly or implicitly described herein, according to different aspects of the present disclosure. For example, a computer equipped with network function may be configured as the apparatus 2600. In some aspect, apparatus 2600 can be a device that connects to the network infrastructure over a radio interface, such as a mobile phone, smart phone or other such device that may be classified as user equipment (UE). In some aspects, the apparatus 2600 may be a Machine Type Communications (MTC) device (also referred to as a machine-to-machine (m2m) device), or another such device that may be categorized as a UE despite not providing a direct service to a user. In some embodiments, apparatus 2600 is capable of Wi-Fi™ connectivity, including the transmission and reception of Wi-Fi™ frames, including IEEE 802.11 frames. In some embodiments, apparatus 2600 is equipped to perform channel estimation for optimizing wireless communication. In some embodiments, apparatus 2600 is designed to support Wi-Fi™ 8 technology and future advancements. In some aspects, apparatus 2600 may be used to implement one or more aspects described herein. In some embodiments, the apparatus 2600 may be a user equipment (UE), an AP, a STA, a transmitter, a receiver, another IEEE 802.11 or Wi-Fi™ device, or the like as appreciated by a person skilled in the art.

As shown, the apparatus 2600 may include a processor 2610, such as a Central Processing Unit (CPU) or specialized processors such as a Graphics Processing Unit (GPU) or other such processor unit, memory 2620, non-transitory mass storage 2630, input-output interface 2640, network interface 2650, and a transceiver 2660, all of which are communicatively coupled via bi-directional bus 2670. Transceiver 2660 may include one or multiple antennas. According to certain aspects, any or all of the depicted elements may be utilized, or only a subset of the elements. Further, apparatus 2600 may contain multiple instances of certain elements, such as multiple processors, memories, or transceivers. Also, elements of the hardware device may be directly coupled to other elements without the bi-directional bus. Additionally, or alternatively to a processor and memory, other electronics or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

The memory 2620 may include any type of non-transitory memory such as static random-access memory (SRAM), dynamic random-access memory (DRAM), synchronous DRAM (SDRAM), read-only memory (ROM), any combination of such, or the like. The mass storage element 2630 may include any type of non-transitory storage device, such as a solid-state drive, hard disk drive, a magnetic disk drive, an optical disk drive, USB drive, or any computer program product configured to store data and machine executable program code. According to certain aspects, the memory 2620 or mass storage 2630 may have recorded thereon statements and instructions executable by the processor 2610 for performing any method operations described herein.

The processor 2610 and memory 2620 may function together as a chipset which may be provided together for installation into wireless communication apparatus 2600 in order to implement WLAN functionality. The chipset may be configured to receive as input data including but not limited to PPDUs from the network interface 2650. The chipset may be configured to output data including but not limited to PPDUs to the network interface 2650. Embodiments may be implemented using a chipset (which may or may not contain a processor and memory) or other set of electronic device components. A processor may be a specialized processor. Electronic device components may include digital circuitry, analog circuitry, or a combination thereof, configured to receive bit sequences and operate on the bit sequences as described herein. Different blocks of circuitry may be configured to perform different functions as described herein, and operatively coupled together. Operations may be parallelized, pipelined, etc. The operations can include operations corresponding to antenna selection for spatial modulation, bit sequence parsing, conversion of bits to symbols, and the like. Transmission by antennas and related operations such as power amplification can be included in some embodiments.

In some embodiments, apparatus 2600 may include any suitable structure for generating signals, such as control signals, for wireless transmission to one or more network nodes. In some embodiments apparatus 2600 further includes one or more antennas which may be based on any suitable structure for transmitting and/or receiving wireless signals. The one or more antennas may be coupled to the transceiver 2660.

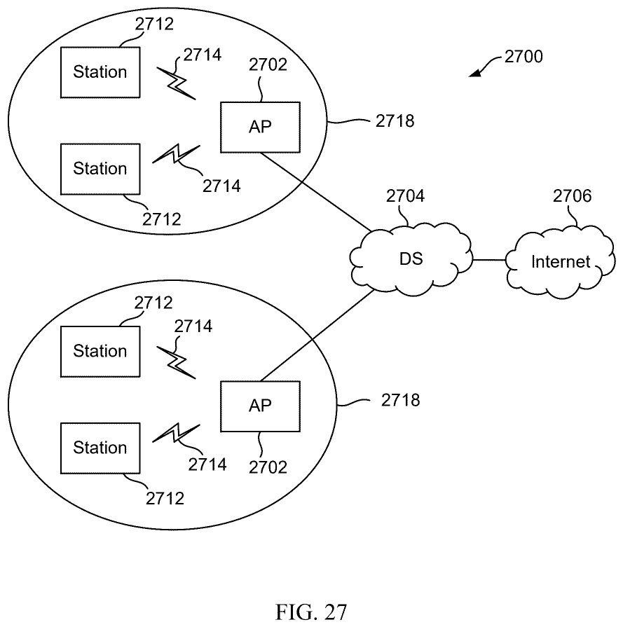

In some embodiments, processor 2610 is configured for performing various processing operations such one or more of: as signal coding, data processing, power control, input/output processing, and any other suitable functionalities to enable the apparatus 2600 to access and join the communication system 2700 (shown FIG. 27) and operate therein.

In some embodiments, the transceiver 2660 may be configured for modulating data or other content for transmission by the at least one antenna to communicate with an AP for example. The transceiver 2660 may also be configured for demodulating data or other content received by the at least one antenna. Each transceiver 2660 may include any suitable structure for generating signals for wireless transmission and/or processing signals received wirelessly. Each antenna may include any suitable structure for transmitting and/or receiving wireless signals. Although shown as a single functional unit, a transceiver 2660 may be implemented separately as at least one transmitter and at least one receiver.

FIG. 27 illustrates a communication system 2700, according to an embodiment of the present disclosure. The communication system 2700 may be a WI-FI™ system built under relevant standards, such as IEEE 802. 11 standard, for example, for a WLAN prioritizing UHR. The communication system 2700 includes a plurality of interconnected networking devices 2702, such as a plurality of interconnected access points (APs such as WI-FI™ 8 APs; which may also be referred to as “base stations”) forming a distribution system (DS) 2704 which is connected to other networks, such as the Internet 2706, which may include a network of computers and subnets (intranets) or both, and incorporate protocols, such as Internet Protocol (IP), Transmission Control Protocol (TCP), User Datagram Protocol (UDP), and/or the like.

Each AP 2702 is in wireless communication with one or more mobile or stationary stations 2712 (STAs) through respective wireless channels 2714 for providing wireless network connections thereto. Herein, the APs 2702 and STAs 2712 may be considered as different types of network nodes (or simply “nodes”) of the communication system 2700. Together, each AP 2702 and the STAs 2712 connected thereto form a cell or basic service set (BSS) 2718.

In embodiments, the STAs 2712 may be any suitable wireless device that may join the communication system 2700 via an AP 2702 for wireless operation. In various embodiments, a STA 2712 may be a wireless electronic device used by a human or user (such as a smartphone, a cellphone, a personal digital assistant (PDA), a laptop, a desktop computer, a tablet, a smart watch, a consumer electronics device, and/or the like). An STA 2712 may be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation or application, the STA 2712 may be movable autonomously or under the direct and/or remote control of a human, or may be positioned at a fixed position.

In some embodiments, an STA 2712 may be a multimode wireless electronic device capable of operation according to multiple radio access technologies and incorporate multiple transceivers necessary to support such.

In embodiments, some or all of the STAs 2712 include functionality for communicating with different wireless devices and/or wireless networks via different wireless links using different wireless technologies and/or protocols. Instead of wireless communication (or in addition thereto), some or all of STAs 2712 may communicate via wired communication channels to other devices or switches (not shown), and to the Internet 2706. For example, a plurality of STAs 2712 (such as STAs 2712 in proximity with each other) may communicate with each other directly via suitable wired or wireless sidelinks.

In the communication between the AP 2702 and the STA 2712, a transmission from the STA 2712 to the AP 2702 may typically be denoted as an uplink (UL), and the wireless channel used therefor is denoted an uplink channel. A transmission from the AP 2702 to the STA 2712 may typically be denoted as a downlink (DL), and the wireless channel used therefor is denoted a downlink channel. Suitable modulation technologies may be used for communication between the AP 2702 and the STA 2712. For example, in some embodiments, orthogonal frequency-division multiplexing (OFDM) may be used wherein the channel 2714 is partitioned into a plurality orthogonal subchannels for communication between the AP 2702 and the STA 2712. In embodiments where a plurality of STAs 2712 is in communication with a same AP 2702, suitable multiple-access technologies may be used. For example, in some embodiments, orthogonal frequency-division multiple access (OFDMA) may be used for communication between the AP 2702 and STAs 2712.

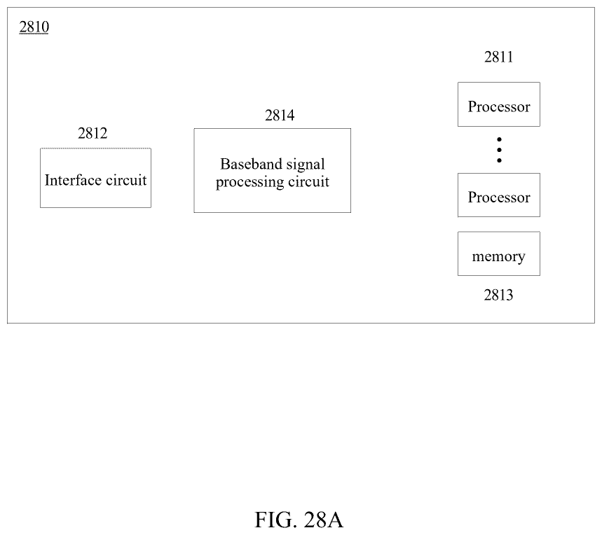

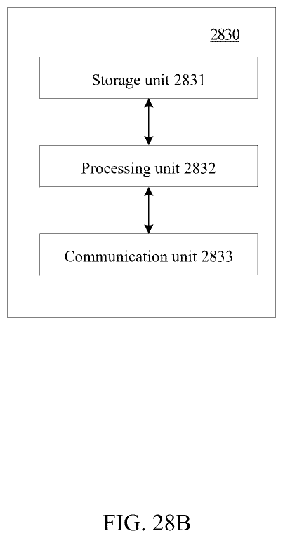

FIG. 28A illustrates an example of an apparatus 2810, according to an embodiment of the present disclosure. The apparatus 2810 may be a communication device or an apparatus implemented in a communication device in one or more embodiments described herein. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components. In some implementations, the apparatus 2810 may be similar to or a module in apparatus 2600.

In an example, the apparatus 2810 may include one or more processors/processor cores 2811, and an interface circuit 2812. The apparatus 2810 may further include a memory 2813. The one or more processors/processor cores 2811 are configured to process signals and execute one or more communication protocols. The memory 2813 is configured to store at least a part of corresponding computer program instructions and/or data. In an example, the one or more processors (or processor cores) 2811 execute the computer program instructions stored in the memory 2813 to implement related operations (for example, inputting, outputting, receiving, and transmitting) in the foregoing method embodiments. In some implementations, the memory 2813 being configured to store the corresponding computer program instructions and/or data may mean that the memory 2813 is configured to store all of the corresponding computer program instructions and/or data for execution by the one or more processors/processor cores 2811. In some implementations, the memory 2813 being configured to store the corresponding computer program instructions and/or data may mean that the memory 2813 is configured to store a part of the corresponding computer program instructions and/or data. For example, the part of the corresponding computer program instructions and/or data include computer program instructions and/or data that need to be currently executed by the one or more processors/processor cores 2811. Thus, the memory 2813 may store different parts of computer program instructions and/or data for a plurality times for the one or more processors(or processor cores) 2811 to perform related operations in the foregoing method embodiments. As a communication interface, the interface circuit 2812 is configured to implement communication with another component. For example, the interface circuit 2812 may communicate a signal with other apparatus/system such as a radio frequency processing apparatus, or processor system. Optionally, to reduce a load of the processor core, a baseband signal processing circuit 2814 may be also disposed to implement processing of at least a part of baseband signals, including signal demodulation, modulation, encoding, decoding, or the like.

Apparatus 2810 may be processor 2610 in apparatus 2600, in some scenario, or included in processor 2610 in apparatus 2600. Apparatus 2810 may be or include a baseband chip. In some implementations, the apparatus 2810 may be independently packaged into a chip. In some implementations, the apparatus 2600 includes different types of chips. The apparatus 2810 may be packaged into a processor chip (for example, a SoC chip or an SIP chip) with the different types of chips. In some implementations, the apparatus 2810 may be packaged into a chip with some or all of circuits of a radio frequency processing system that may further included in the apparatus 2600.

FIG. 28B illustrates an example apparatus 2830, according to an embodiment of the present disclosure. Apparatus 2830 may include corresponding modules or units configured to implement methods and/or embodiments described herein. In some implementations, the apparatus 2830 includes a processing unit 2832 and a communication unit 2833. Optionally, the apparatus 2830 may further include a storage unit 2831 configured to store apparatus program code (or instructions) and/or data.

In some embodiments, the apparatus 2830 may be a module, or a circuit or a chip responsible for a communication function in apparatus 2600. In some implementations, apparatus 2830 may be implemented as apparatus 2600, accordingly, the processing unit 2832 is implemented as processor 2610, the communication unit 2833 is implemented as transceiver 2660, and the storage unit 2831 is implemented as memory 2620.

In some implementations, a function of the apparatus 2830 may be implemented by one or more processors. Specifically, the processor may include a modem chip, or a system on chip SoC chip or an SIP chip that includes a modem core. A function of the communication unit 2833 may be implemented by a transceiver circuit.

In some implementations, when the apparatus 2830 is a circuit or a chip that is responsible for a communication function, for example, a modem chip, a system on chip SoC chip or an SIP chip that includes a modem core, a function of the processing unit 2832 may be implemented by a circuit system that is in the chip and that includes one or more processors or processor cores. A function of the communication unit 2833 may be implemented by an interface circuit or a data transceiver circuit on the foregoing chip.

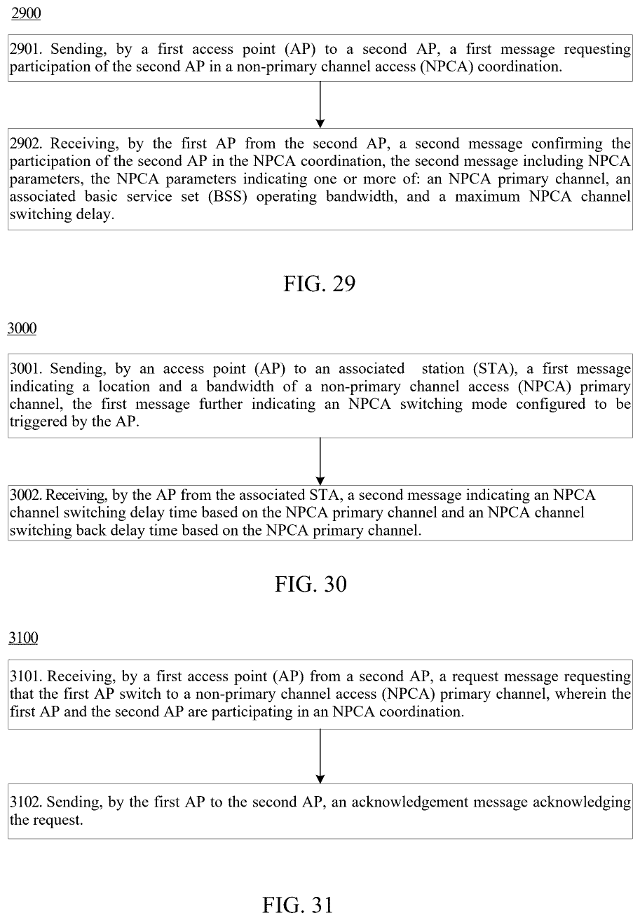

FIG. 29 illustrates an inter-BSS coordination method according to an embodiment. The method 2900 may facilitates coordination between two APs in overlapping basic service sets to manage non-primary channel access. Method 2900 includes sending 2901, by a first AP to a second AP, a first message requesting participation of the second AP in an NPCA coordination. Method 2900 further includes receiving 2902, by the first AP from the second AP, a second message confirming the participation of the second AP in the NPCA coordination, the second message including NPCA parameters. The method 2900 may further encompass various additional steps and configurations as described herein, including but not limited to enhanced message exchanges, parameter updates, and coordination processes between access points, which may facilitate improved NPCA coordination.

FIG. 30 illustrates an intra-BSS coordination method according to an embodiment. Method 3000 may provide for coordinating NPCA within a single BSS by managing channel switching delays and NPCA switching modes. Method 3000 includes sending 3001, by an AP to an associated STA, a first message indicating a location and a bandwidth of an NPCA primary channel. The first message may indicate an NPCA switching mode configured to be triggered by the AP. Method 3000 further includes receiving 3002, by the AP from the associated non-AP STA, a second message indicating an NPCA channel switching delay time based on the NPCA primary channel and an NPCA channel switching back delay time. The NPCA channel switching delay time may indicate a first time or duration for the associated STA to switch from a primary channel to the NPCA primary channel. The NPCA channel switching back delay time may indicate a second time or duration for the associated STA to switch back from the NPCA primary channel. In some embodiments, the NPCA switching mode is indicated by an UHR MAC capabilities information field of an UHR capabilities element or is indicated by a separate NPCA capability element.

FIG. 31 illustrates a method for coordinating the sharing of TXOP, according to an embodiment. Method 3100 includes receiving 3101, by a first AP from a second AP, a request message requesting that the first AP switch to an NPCA primary channel, wherein the first AP and the second AP are participating in an NPCA coordination. Method 3100 further includes sending 3102, by the first AP to the second AP, an acknowledgement message acknowledging the request. Method 3100 may encompass further features related to the coordination of channel switching between access points (APs) and associated non-AP stations (non-AP STAs), as described in the embodiments herein. These additional elements include, among others, the exchange of trigger frames and acknowledgment messages with STAs, the handling of NPCA parameters, and the reporting of channel switching delays from STAs, supporting efficient timing and coordination for NPCA channel access.

According to embodiments described herein, the methods 2900, 3000, and 3100, along with their respective features, may be implemented individually or in combination. The described methods facilitate coordination and communication in managing NPCA and interactions between access points (APs) and associated non-AP stations (non-AP STAs). These embodiments may allow for flexible and adaptable system configurations, where various aspects of NPCA coordination and channel switching can be integrated to achieve optimized performance.

In the present disclosure, the terms “a” or “an” are defined to mean “at least one”, that is, these terms do not exclude a plural number of items, unless stated otherwise. As used herein, the terms ‘field’ and ‘subfield’ may be used interchangeably where appropriate. In certain contexts, a ‘field’ may refer to what has been described as a ‘subfield,’ or a ‘subfield’ may be described as a ‘field,’ depending on the level of abstraction or detail in the specific embodiment. This interchangeable use is intended to simplify the description and should not be interpreted as limiting. A person of ordinary skill in the art will understand the appropriate scope and meaning of these terms based on the context in which they are used, and such usage should not limit the scope or interpretation of the embodiments as disclosed.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of the example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with”or similar expressions.

In the present disclosure, the terms “system” and “network” may be used interchangeably in embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the other programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It may be understood that division into the units in the foregoing apparatus is merely logical function division. Each function may correspond to one functional unit, or two or more functions may be integrated into one functional unit. In actual implementation, all or some of the units may be integrated into one physical entity, or may be distributed in different physical entities. In addition, the foregoing functional units may be implemented in a form of hardware, may be implemented in a form of software, or may be implemented in a form of a combination of hardware and software.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is

1. A method comprising:
sending, by a first access point (AP) to a second AP, a first message requesting participation of the second AP in a non-primary channel access (NPCA) coordination; and
receiving, by the first AP from the second AP, a second message confirming the participation of the second AP in the NPCA coordination, the second message including NPCA parameters, the NPCA parameters indicating one or more of:
a location of an NPCA primary channel,
a bandwidth of the NPCA primary channel,
an associated basic service set (BSS) operating bandwidth, and
a maximum NPCA channel switching delay within the associated BSS.

2. The method of claim 1 further comprising:
sending, by the first AP to the second AP, a third message including recommended NPCA parameters, the recommended NPCA parameters indicating a recommended NPCA primary channel;
receiving, by the first AP from the second AP, a fourth message indicating one of:
an acceptance of the recommended NPCA parameters;
a rejection of the recommended NPCA parameters; and
an alternative set of NPCA parameters, the alternative set of NPCA parameters indicating an alternative NPCA primary channel.

3. The method of claim 2, wherein the fourth message indicates:
the acceptance of the recommended NPCA parameters, and an updated maximum NPCA channel switching delay based on the alternative NPCA primary channel.

4. The method of claim 1 further comprising:
assigning, by the first AP to the second AP, an identifier (ID) by setting an associated identifier (AID)12 bits subfield to a value selected from one or more ranges including: 1 to 2006, 2008 to 2044, and 2047 to 4094.

5. The method of claim 1, wherein the first AP is in a first BSS, and the second AP is in a second BSS, the second BSS overlapping the first BSS, the method further comprising:
sending, by the first AP to each third AP of one or more third APs, a third message requesting participation of said each third AP in the NPCA coordination; and
receiving, by the first AP from said each third AP, a fourth message confirming the participation of said each third AP in the NPCA coordination.

6. A method comprising:
sending, by an access point (AP) to an associated station (STA), a first message indicating a location and a bandwidth of a non-primary channel access (NPCA) primary channel, the first message further indicating an NPCA switching mode configured to be triggered by the AP; and
receiving, by the AP from the associated STA, a second message indicating an NPCA channel switching delay time based on the NPCA primary channel and an NPCA channel switching back delay time based on the NPCA primary channel, the NPCA channel switching delay time indicating a first time for the associated STA to switch from a primary channel to the NPCA primary channel, and the NPCA channel switching back delay time indicating a second time for the associated STA to switch back from the NPCA primary channel to the primary channel.

7. The method of claim 6, wherein the NPCA switching mode is indicated by a medium access control (MAC) capabilities information field of an ultra-high reliability (UHR) capabilities element.

8. A method comprising:
receiving, by a first access point (AP) from a second AP, a request message requesting that the first AP switch to a non-primary channel access (NPCA) primary channel, wherein the first AP and the second AP are participating in an NPCA coordination;
sending, by the first AP to the second AP, an acknowledgement message acknowledging the request.

9. The method of claim 8, wherein the request message is comprised in a trigger frame indicated by a trigger type subfield within a common info field.

10. The method of claim 9, wherein:
the trigger type subfield indicates: a multi-user block acknowledgement request (MU-BAR) trigger frame, a multi-user request-to-send (MU-RTS) trigger frame, a buffer status report poll (BSRP) trigger frame, or a reserved value selected from 9 to 15; and
the trigger frame indicates a transmitting opportunity (TXOP) duration via one of: a trigger dependent user info field or a duration field.

11. The method of claim 8, wherein the acknowledgement message is sent in a multi-STA block acknowledgement (BA) frame that includes a per associated identifier (AID) traffic identifier (TID) info field for acknowledging the request, the acknowledging being indicated via a combination of an ACK type subfield and TID subfield of the per AID TID info field.

12. The method of claim 8 further comprising:
sending, by the first AP to an associated STA, a trigger frame to indicate switching to the NPCA primary channel, the trigger frame including a per associated identifier (AID) traffic identifier (TID) info field, which further includes:
a block ACK starting sequence control subfield indicating a type of control info as being NPCA parameters; and
a block ACK bitmap subfield indicating one or more NPCA parameters including: whether to switch to the NPCA primary channel, an NPCA switching start time, and an NPCA duration.

13. The method of claim 12 further comprising:
receiving, by the AP from the associated STA, a report indicating an NPCA channel switching delay time based on the NPCA primary channel and an NPCA channel switching back delay time based on the NPCA primary channel, the NPCA channel switching delay time indicating a first time for the associated STA to switch from a primary channel to the NPCA primary channel, the NPCA channel switching back delay time indicating a second time for the associated STA to switch back from the NPCA primary channel to the primary channel, wherein the trigger frame further includes zero, one or more additional per AID TID info fields based on the NPCA channel switching delay time, each of the one or more additional per AID TID info fields including:
a corresponding block Ack starting sequence control subfield indicating a type of control info as being intermediate frame check sequence (FCS); and
a corresponding block ACK bitmap subfield including 32 FCS bits.

14. The method of claim 13, wherein the trigger frame further includes a padding user info field with a size based in part on the NPCA channel switching delay time.

15. An apparatus comprising a non-transitory computer readable medium having instructions stored thereon which, when executed by a processor, configure the apparatus for:
receiving, from an access point (AP), a request message requesting that the apparatus switch to a non-primary channel access (NPCA) primary channel, wherein the apparatus and the AP are participating in an NPCA coordination;
sending, to the second AP, an acknowledgement message acknowledging the request.

16. The apparatus of claim 15, wherein the request message is comprised in a trigger frame indicated by a trigger type subfield within a common info field.

17. The apparatus of claim 16, wherein:
the trigger type subfield indicates: a multi-user block acknowledgement request (MU-BAR) trigger frame, a multi-user request-to-send (MU-RTS) trigger frame, a buffer status report poll (BSRP) trigger frame, or a reserved value selected from 9 to 15; and
the trigger frame includes indicates a transmitting opportunity (TXOP) duration via one of: a trigger dependent user info field or a duration field.

18. The apparatus of claim 15, wherein the acknowledgement message is sent in a multi-STA block acknowledgement (BA) frame that includes a per associated identifier (AID) traffic identifier (TID) info field for acknowledging the request, the acknowledging being indicated via a combination of an ACK type subfield and TID subfield of the per AID TID info field.

19. The apparatus of claim 15, wherein the instructions when executed by the processor further configure the apparatus for:
sending, to an associated STA, a trigger frame to indicate switching to the NPCA primary channel, the trigger frame including a per associated identifier (AID) traffic identifier (TID) info field, which further includes:
a block ACK starting sequence control subfield indicating a type of control info as being NPCA parameters; and
a block ACK bitmap subfield indicating one or more NPCA parameters including: whether to switch to the NPCA primary channel, an NPCA switching start time, and an NPCA duration; and
receiving, from the associated STA, a report indicating an NPCA channel switching delay time based on the NPCA primary channel and an NPCA channel switching back delay time based on the NPCA primary channel, the NPCA channel switching delay time indicating a first time for the associated STA to switch from a primary channel to the NPCA primary channel, the NPCA channel switching back delay time indicating a second time for the associated STA to switch back from the NPCA primary channel to the primary channel, wherein the trigger frame further includes zero, one or more additional per AID TID info fields based on the NPCA channel switching delay time, each of the one or more additional per AID TID info fields including:
a corresponding block Ack starting sequence control subfield indicating a type of control info as being intermediate frame check sequence (FCS); and
a corresponding block ACK bitmap subfield including 32 FCS bits.

20. The apparatus of claim 19, wherein the trigger frame further includes a padding user info field with a size based in part on the channel switching delay time, and wherein a channel switching delay requirement of the associated STA is based on one of:
the NPCA primary channel being outside of an operating bandwidth of the associated STA;
the NPCA primary channel being within the operating bandwidth of the associated STA; and
a minimal channel switching delay requirement.
